(19) United States
(12) Patent Application Publication
(10) Pub. No.: US 2021/0154916 A1
(43) Pub. Date: May 27, 2021

(54) NOZZLES, HOT ENDS, AND METHODS OF THEIR USE

(71) Applicant: University of Massachusetts, Boston, MA (US)

(72) Inventor: David O. Kazmer, Georgetown, MA (US)

(21) Appl. No.: 17/103,339

(22) Filed: Nov. 24, 2020

Related U.S. Application Data
(60) Provisional application No. 62/940,409, filed on Nov. 26, 2019.
(60) Provisional application No. 63/030,682, filed on May 27, 2020.

(51) Int. Cl. B29C 64/118; B29C 64/209; B29C 64/393; B33Y 50/02; B29C 64/314; B29C 64/295

(52) U.S. Cl. CPC B29C 64/118; B29C 64/209; B29C 64/393; B33Y 10/00; B29C 64/314; B29C 64/295; B33Y 50/02

(57) ABSTRACT

3D printing nozzles, hot ends, and methods for their use are described. Configurations as described herein provide for apparatus and methods that deliver (i) higher melting rates, (ii) improved processing consistency, (iii) faster printing speeds, (iv) improved printed product quality, and (v) quality assurance. Methods for on-line characterization of material viscosity and compression are provided using an instrumented apparatus. Methods for controlling the 3D printing process based on feedback from instrumentation as well as simulation are also described.

### RELATED APPLICATION

This application claims the benefit of earlier filed U.S. Provisional Patent Application Ser. No. 62/940,409 entitled “NOZZLES, HOT ENDS, AND METHODS OF THEIR USE,” (Attorney Docket No. UML19-09(2020-015-01)p), filed on Nov. 26, 2019, the entire teachings of which are incorporated herein by this reference.

This application claims the benefit of earlier filed U.S. Provisional Patent Application Ser. No. 63/030,682 entitled “NOZZLES, HOT ENDS, AND METHODS OF THEIR USE,” (Attorney Docket No. UML2020-037-01p), filed on May 27, 2020, the entire teachings of which are incorporated herein by this reference.

### BACKGROUND

Conventional 3-D (three-dimensional) printers have been used to fabricate different types of objects.

### BRIEF DESCRIPTION OF EMBODIMENTS

The embodiments described herein pertain to a type of fused filament fabrication (FFF process), also referred to as fused deposition modeling (FDM) and extrusion deposition (ED) and material extrusion (ME) and by other terms. Generally, these technologies decompose a part's three-dimensional (3D) geometry into a series of printed roads that are consecutively printed to reproduce the part's 3D geometry. Herein, the word “part” means the product being produced by the 3D printing process by additive manufacturing. The part or product may be a device or article for sale, a component that is assembled or finished, or more generally a form of matter having a defined geometry.

Certain embodiments herein provide an apparatus for improved melting and sensing of processed materials or flowable material to achieve higher production speeds and quality. The flowable material includes any type of matter such as one or more of a solid, a liquid, a gas, etc. Methods are described for monitoring and controlling the 3D printing process to achieve higher production speeds and quality.

In standard conventional nozzle designs, a filament having a circular cross section is pushed through a nozzle having an internal bore with a converging circular cross section. The melting rate is constrained by the heat conduction from the outer diameter of the filament to its center. At high rates of flow, drops in the melt temperature have been observed using an instrumented nozzle tip such as described by “Coogan, T. J. and Kazmer, D. O., 2019. In-line rheological monitoring of fused deposition modeling. Journal of Rheology, 63(1), pp. 141-155.”

In contrast to conventional techniques, the novel melt channel geometry as described herein greatly improves the melting rates of flowable matter by transitioning from a circular section having a diameter at a respective inlet that is approximately equal to the filament diameter to a melting zone (such as flow channel) that is wider and thinner than the diameter at the inlet. This wider and thinner section (such as flow channel) provides for a larger perimeter, larger contact (surface) area, and greater rates of heat transfer compared to a circular section. At the same time, the thinness of the wider and thinner section (flow channel) provides for a reduced time of heating the flowable material compared to the circular section. In combination, the melting rates are greatly improved. Moreover, the planar shape or substantially planar shape of the wider and thinner section (flow channel) provides a flat outer surface that is readily fitted with one or more sensors or sensing elements (such as to monitor one or more of temperature, pressure, etc.) for monitoring and control surfaces. The width of the wider and thinner section (flow channel) enables implementation of a larger sensor to monitor the flowable material in the flow channel than could otherwise be provided with the conventional circular section having a diameter that is approximately equal to the filament diameter. The capability of the sensors are greatly improved, including multi-modal sensors with higher signal to noise ratios than smaller sensors.

In operation of the 3D printing process, we have observed limitations related to the compressibility (compression) and creeping flow of the molten feedstock. Specifically, we have observed excess delivery of material when the process transitions from higher melt pressures and volumetric flow rates to lower melt pressures and volumetric flow rates. We have also observed insufficient delivery of material when the process transitions from lower melt pressures and volumetric flow rates to higher melt pressures and volumetric flow rates. We have also observed drool (undesired leakage of melt from the nozzle orifice) when no material is supposed to be extruded. The described embodiments herein greatly improve these issues through various features that may be implemented individually optionally or in combination including one or more qualities such as (i) apparatus with improved heating and observability, (ii) methods for monitoring and control, (iii) method for compressibility (i.e., compression) compensation without instrumentation, (iv) and other inventive feature described herein.

The embodiments described herein are generally suitable for FFF/FDM/ED/ME types processes as well as the injection printing methods as well as other. The embodiments as described herein also provide certain inventive features for related components including, for example, heat breaks, nozzle tips, heater cartridges, temperature sensors, insulating enclosures, melt sensors, methods of their use including one or more of:
A first embodiment providing a melt channel having a circular inlet transitioning to a wider and thinner section.
A second embodiment providing a nozzle with a melt channel of the first embodiment.
A third embodiment providing a method of additive manufacturing nozzles and hot ends.
A fourth embodiment providing the design of an instrumented hot end and extruder adaptor for use with a downstream threaded nozzle tip.
A fifth embodiment providing the design of an instrumented hot end for use with a threaded upstream heat break and a downstream threaded nozzle tip.
A sixth embodiment providing the design of an instrumented hot end with a lightweight, cooling support plate as well as a melt sensor pin having an integrated thermocouple.
A seventh embodiment providing the design of an instrumented hot end mounted to a support plate also supporting the load sensor and an accelerometer. The seventh embodiment also discloses the use of a melt sensor pin with internal optical material for transmitting infrared or other optical information.
An eighth embodiment describing a method for sensing one or more states for a material being processed.
A ninth embodiment for characterizing the viscosity and compressibility (compression) of a material being processed based on feedback from sensed process states.
A tenth embodiment for controlling a material being processed based on feedback from sensed process states.
An eleventh embodiment for simulating the compressible flow of a candidate material based on machine instructions and a material constitutive model.
A twelfth embodiment for correcting machine instructions based on simulated compressible flow.
A thirteenth embodiment for using figures of merit to evaluate the suitability of a printing process or a printed part.

Note that yet further embodiments herein include an apparatus comprising a conduit. The conduit comprises: an inlet operative to receive a material; an outlet operative to output the processed material; a flow channel disposed between the inlet and outlet, the flow channel operative to receive the material from the inlet and convey the processed material to the outlet, the flow channel in the conduit defined by a cross-sectional width and cross-sectional thickness; and the cross-sectional width being greater than the cross-sectional thickness.

In accordance with further example embodiments, the inlet has a rounded cross section. The cross-sectional width of the flow channel is greater than a diameter of the rounded cross section. The cross-sectional thickness of the flow channel is less than a diameter of the rounded cross section.

In yet further example embodiments, a cross section of the flow channel is oblong, such as like a rectangle with rounded sides or an oval.

In accordance with further example embodiments, the apparatus includes an opening disposed on a surface of the flow channel; and a sensing element disposed through the opening to monitor the material. In one nonlimiting example embodiment, the sensing element is comprised of a material to transmit an optical signal.

In still further example embodiments, the flow channel is connected to the inlet via a lofted section.

In accordance with further embodiments, the flow channel is connected to the outlet via a lofted section.

In yet further example embodiments, the conduit is produced via an additive manufacturing process. Additionally, or alternatively, the conduit is produced via a machining process.

In accordance with further embodiments, the apparatus includes a sensing element operative to monitor the material passing through the flow channel.

In yet further example embodiments, the apparatus includes: i) a sensing element operative to generate a signal based on monitoring the material passing through the flow channel; and ii) a controller operative to receive the signal produced by the sensing element and control a flow of the material through the flow channel based on the signal.

In still further example embodiments, the apparatus includes: i) a first sensing element operative to generate a temperature signal based on monitoring a temperature of the material passing through the flow channel; ii) a second sensing element operative to generate a pressure signal based on monitoring a pressure of the material passing through the flow channel; and iii) a controller operative to control a flow of the material through the flow channel based on the temperature signal and the pressure signal.

Further embodiments of the apparatus as described herein includes: a window disposed on a surface of the flow channel, the first sensor and the second sensor disposed in a vicinity of the window to monitor the material.

Still further example embodiments include a method comprising: receiving a signal produced by a sensing element, the sending element producing the signal based on monitored attributes of the flowable material passing through the flow channel.

Further embodiments herein include, via the fluid channel, controlling a rate of the flowable material flowing through the flow channel based at least in part on the signal produced by the sensing element. In one embodiment, the signal indicates a pressure of the material disposed in the flow channel.

Further embodiments herein include estimating the pressure of the material in the flow channel based on a viscosity model.

Further embodiments herein include estimating a compressibility of the material in the flow channel based on a compressibility (compression) model.

Yet further embodiments herein include estimating an output flow rate of the flowable material passing through the flow channel.

Further embodiments herein include varying the temperature and flow rate of the material in the flow channel in a controlled manner to estimate the viscosity model coefficients and compressibility (compression) model coefficients by comparing the observed pressure and measured road width with estimates of the observed pressure and measured road width.

Still further example embodiments include determining a figure of merit used to determine the acceptance of a part printed via the material outputted from the outlet.

Still further example embodiments herein include adjusting a flow rate of the flowable material into the inlet to control a flow rate of the material from the outlet.

Another example herein includes a method for simulating a 3D printing process, the method comprising: reading a set of machine instructions; estimating process states of a material to be processed; estimating an outlet flow rate based on compressible flow behavior; predicting quality attributes of the material; and determining the suitability of the 3D printing process to produce a printed object.

In one embodiment, the method further includes determining the suitability of the 3D printing process based on multiple figures of merit.

In still further example embodiments, the simulating of the 3D printing process updates the set of machine instructions to control the printed road widths. In yet further example embodiments, simulating of the 3D printing process includes updating the set of machine instructions to provide a faster printing process.

Embodiments herein further include an apparatus for 3D printing. The apparatus includes a conduit. The conduit comprises: an inlet operative to receive a material; an outlet operative to output the processed material; a flow channel disposed between the inlet and outlet, the flow channel having a cross-sectional width and cross-sectional thickness, the cross-sectional width being greater than the cross-sectional thickness.

In accordance with further example embodiments, the inlet of the conduit has a rounded cross section.

In still further example embodiments, the cross-sectional width of the flow channel is greater than a diameter of the rounded cross section; the cross-sectional thickness of the flow channel is less than a diameter of the rounded cross section.

In one embodiment, the Applicant includes: an opening disposed on a surface of the flow channel; and a sensing element disposed through the opening to monitor the material.

In accordance with further example embodiments, the flow channel of the conduit is connected to the inlet via a lofted section.

In further example embodiments, the flow channel section of the conduit is connected to the outlet via a lofted section.

In one embodiment, the conduit is produced via an additive manufacturing process. Additionally, or alternatively, the conduit is produced via a machining process.

In yet further example embodiments, the apparatus includes a sensing element that generates a signal based on monitoring the material passing through the flow channel. The apparatus further includes a controller operative to receive the signal and control a flow of the processed material through the flow channel based on the signal.

Further embodiments herein include receiving a signal produced by a sensor element in the apparatus. The sensor element produces the signal based on monitored attributes of the material passing through the flow channel of the conduit. A controller or other suitable resource controls a rate of the material flowing through the flow channel based on the signal (such as pressure, temperature, etc.) produced by the sensor.

In accordance with further example embodiments, the signal from the sensor element indicates a pressure or other suitable monitored parameter of the flowable material disposed in the fluid pathway section.

Further embodiments herein include estimating a viscosity of the material in the flow channel such as based on one or more parameters such as temperature, pressure, etc. of the material in the flow channel. Further embodiments herein include additionally, or alternatively, estimating and amount of compression of the material in the flow channel of the conduit.

Further embodiments herein include determining a figure of merit used to determine the acceptance of a part printed via the fluid outputted from the outlet.

Further embodiments herein include estimating an output flow rate of the material from the flow channel and adjusting a flow rate of the material into the inlet to control a flow rate of the material from the outlet.

Another embodiment herein includes a method for printing a component, the method includes: sensing a melt pressure of a material being processed during a printing process; estimating a volumetric change of the material due to compression of the material during the printing process; and varying an inlet flow rate of the material to compensate for the estimated volumetric change due to the compression. The volumetric change of the material (such as in the flow channel of the nozzle) is estimated as a function of the sensed pressure.

Further embodiments herein include, via a controller, estimating an output flow rate of the material from an outlet of a print nozzle based on the established volumetric change. Additionally, or alternatively, the controller adjusts the inlet flow rate to control the outlet flow rate to a target value.

Another embodiments herein includes a method for printing a component, the method comprising: reading a machine program for a planned printing process of a material to be printed; simulating a melt pressure during the planned printing process; simulating the volumetric change of the material due to compressibility (estimated compression); simulating the inlet flow rate of the material during the planned process in order to compensate for the volumetric change due to compressibility (estimated compression); revising the planned machine program for the planned printing process in order to compensate for the volumetric change due to compressibility; and using the revised machine program in another printing process.

In one embodiment, the inlet flow rate is varied to control a printed road width.

In another embodiment, the compensation for the volumetric change due to compressibility (i.e. compression) of the material in the print nozzle allows revision of the planned machine program, which provides a faster printing process.

Another embodiments herein includes a method for printing a component, the method comprising: sensing the melt pressure during the printing process; estimating the volumetric change due to compressibility (compression) of the material being processed with the sensed melt pressure; and varying the volumetric flow rate of the extruded material to compensate for the volumetric change due to compressibility (compression) of the material being processed.

Another embodiments herein includes a method for printing a component, the method comprising: estimating the melt pressure during a printing process; estimating the volumetric change due to compressibility (compression) of the material given the estimated melt pressure; and varying the volumetric flow rate of the material being extruded in order to compensate for the volumetric change due to compressibility (compression) of the material being processed.

Another embodiments herein includes a method for printing a component, the method comprising: reading a machine program for a printing process; estimating the melt pressure during the planned printing process; estimating the volumetric change due to compressibility (compression) of the material given the estimated melt pressure; varying the volumetric flow rate of the material being extruded in order to compensate for the volumetric change due to compressibility (compression) of the material being processed; writing a revised machine program for a printing process; and using the revised machine program in a printing process.

In one embodiment, the segments printed by a machine program are subdivided into smaller segments, each smaller segment being provided its own compressibility (compression) compensation.

Another embodiments herein includes a method for calibrating the compressibility (compression) correction, the method comprising: printing a component at varying flow rates; observing the melt pressures as a function of flow rate; modeling the material viscosity as a function of shear rate given the melt pressures as a function of flow rate; measuring the dimensions of the printed component; adjusting the model coefficients for the volume and bulk modulus of the material in the hot end.

Another embodiments herein includes a method comprising: sensing a pressure of a material in a flow path during a printing process of fabricating a component, the material outputted from the flow path to produce the component; based on the pressure, estimating a volumetric change of the material in the flow path due to compression of the material during the printing process; and varying an inlet flow rate of the material from a source into the flow path to compensate for the estimated volumetric change of material due to the compression.

Additionally, in one embodiment, estimating the volumetric change in the material in the flow path includes: inputting the sensed pressure to a model that estimates the volumetric change of the material.

Further embodiments of the method as described herein include receiving a temperature value indicative of a temperature of the material in the flow path; and estimating the volumetric change of the material based on the temperature.

Further embodiments of the method as described herein estimating an output flow rate of the material from an outlet of a print nozzle of the flow path based on the estimated volumetric change.

In still further example embodiments, varying the inlet flow rate of the material from the source into the flow path includes based on the estimated volumetric change of the material, adjusting the inlet flow rate of material into the flow path. The adjusted inlet flow rate causes a flow rate of the material outputted from the flow path to be a target flow rate value.

Still further example embodiments herein include estimating the volumetric change of the material in the flow path due to compression of the material via a compression model.

In one embodiment, the printing processes as described herein include is a 3D printing process, the method further includes controlling movement of a nozzle in which the flow path resides, output of the material from the flow path and the nozzle producing a road on the component.

Another embodiments herein includes an printing apparatus comprising: a sensor element operative to sense a melt pressure of a material in a flow path during a printing process of fabricating a component, the material outputted from the flow path to produce the component; and a controller. The controller is operative to: i) based on the melt pressure, estimate a volumetric change of the material in the flow path due to compression of the material during the printing process; and ii) vary an inlet flow rate of the material from a source into the flow path to compensate for the estimated volumetric change of material due to the compression.

In accordance with further example embodiments, the controller is further operative to input the sensed pressure to a model that estimates the volumetric change of the material.

In still further example embodiments, the controller is further operative to: receive a temperature value indicative of a temperature of the material in the flow path; and estimate the volumetric change of the material based on the temperature.

Still further example embodiments herein apparatus as in claim 9, wherein the controller is further operative to: estimate an output flow rate of the material from an outlet of a print nozzle of the flow path based on the estimated volumetric change.

In further example embodiments, wherein the controller is further operative to, based on the estimated volumetric change of the material, adjust the inlet flow rate of material into the flow path. In such an instance, the adjusted inlet flow rate causes a flow rate of the material outputted from the flow path to be a target flow rate value.

In an example embodiment, the controller is further operative to estimate the volumetric change of the material in the flow path due to compression of the material via a compression model.

In still further example embodiments, the printing process is a 3D printing process, the controller further operative to control movement of a nozzle in which the flow path resides, output of the material from the flow path and the nozzle producing a road on the component.

Another embodiments herein includes a method comprising: receiving first fabrication instructions to produce a component via a 3D printing process using a first printing system; simulating the printing process via the first printing system, simulation of the printing process via the first printing system including: i) estimating a pressure of a material in a flow path of a nozzle of the first printing system during the simulated printing process of fabricating the component, the material outputted from the flow path to produce the component; ii) based on the estimated pressure, estimating a volumetric change of the material in the flow path due to compression of the material during the simulated printing process; and iii) determining variations of an inlet flow rate of the material from a source into the flow path to compensate for the estimated volumetric change of material due to the compression. Additionally, the method includes deriving second fabrication instructions from the simulation of the printing process, the second fabrication instructions providing compensation of the volumetric change of the material in the flow path due to compression of the material during the simulated printing process.

Further embodiments herein include executing the second fabrication instructions via a second printing system to fabricate a rendition of the component. In one embodiment, the second printing system is a replica of the first printing system.

In still further embodiments, a method comprises: receiving a fabrication program of a planned printing process of fabricating the component via a print material; simulating a melt pressure of the print material during the planned printing process; simulating a volumetric change of the print material due to compression of the material during the planned printing process; simulating an inlet flow rate of the print material into a during the planned process in order to compensate for the volumetric change due to compressibility (compression); and revising the planned machine program for the planned printing process to compensate for the volumetric change due to compression.

In one embodiment, the inlet flow rate in the simulation is varied to control simulation of a printed road width of the component.

In accordance with further example embodiments, the estimated volumetric change due to compression of the material in the flow path supports a revision of the first fabricate instructions into the second fabrication instructions, the second fabrication instructions providing a faster printing process than the first fabrication instructions.

Further embodiments herein include a system comprising: a simulator operative to: receive first fabrication instructions to produce a component via a 3D printing process using a first printing system; simulate the printing process via the first printing system in which the simulator is operative to: i) estimate a pressure of a material in a flow path of a nozzle of the first printing system during the simulated printing process of fabricating the component, the material outputted from the flow path to produce the component; ii) based on the estimated pressure, estimate a volumetric change of the material in the flow path due to compression of the material during the simulated printing process; and iii) determine variations of an inlet flow rate of the material from a source into the flow path to compensate for the estimated volumetric change of material due to the compression; and derive second fabrication instructions from the simulation of the printing process, the second fabrication instructions providing compensation of the volumetric change of the material in the flow path due to compression of the material during the simulated printing process.

In one embodiment, the second fabrication instructions are executable via a second printing system to fabricate a rendition of the component. The second printing system is a replica of the first printing system.

Another embodiments herein includes a method comprising: sensing a melt pressure of material in a flow path during 3D printing of a component; estimating a volumetric change due to compressibility (compression) of the material being processed with the sensed melt pressure; and varying the volumetric flow rate of the extruded material to compensate for the volumetric change due to compressibility (compression) of the material being processed.

Another embodiments herein includes a method for printing a component, the method comprising: estimating a melt pressure during a printing process; estimating a volumetric change due to compressibility (compression) of the material given the estimated melt pressure; and varying a volumetric flow rate of the material being extruded in order to compensate for the volumetric change due to compressibility (compression) of the material being processed.

Another embodiments herein includes a method for printing a component, the method comprising: reading a first machine program defining a printing process; estimating a melt pressure of material during the printing process; estimating a volumetric change due to compression of the material based on the estimated melt pressure; and determining variation in the volumetric flow rate of the material being extruded in order to compensate for the volumetric change due to compressibility (compression) of the material being processed; producing revised machine program for a printing process; and using the revised machine program in a printing process. In one embodiment, segments (such as roads) printed by a machine program are subdivided into smaller segments, each smaller segment being provided its own compressibility (compression) compensation.

Another embodiments herein includes a method for calibrating the compressibility (compression) correction, the method comprising: printing a component at varying flow rates of material through a flow path; observing melt pressures of the material in the flow path as a function of flow rate; modeling a viscosity of the material as a function of shear rate based on the melt pressures as a function of flow rate; measuring dimensions of a printed road of the component; and adjusting the model coefficients for the volume and bulk modulus of the material in the flow path. BRIEF DESCRIPTION OF THE

### DRAWINGS

FIG. 1 provides an isometric view of a melt channel having a circular inlet transitioning to a wider and thinner section (such as flow channel) according to embodiments herein.

FIG. 2 provides a partial isometric view of a nozzle with a melt channel (such as a flow channel) of FIG. 1 and other features according to embodiments herein.

FIG. 2A provides an isometric view of a tree of nozzle patterns for use with an additive manufacturing process according to embodiments herein.

FIG. 3 provides an isometric view an instrumented hot end and extruder adaptor for use with a standard nozzle tip according to embodiments herein.

FIG. 4 provides a section view through the instrumentation according to the section lines 4-4 indicated in FIG. 3 according to embodiments herein.

FIG. 5 provides a section view through the arms of the hot end and extruder adaptor according to the section lines 5-5 indicated in FIG. 3 according to embodiments herein.

FIG. 6 provides a partial isometric view of an alternative design of the hot end having an upper threaded inlet for use with a threaded upstream heat break according to embodiments herein.

FIG. 7 provides a partial isometric view of an instrumented hot end with a lightweight, cooling support plate as well as a melt sensor pin having an integrated thermocouple according to embodiments herein.

FIG. 8 provides a partial isometric view of an instrumented hot end mounted to a support plate also supporting the load sensor and an accelerometer according to embodiments herein.

FIG. 8A provides a detail view of FIG. 8 disclosing the use of an adjustable melt sensor pin with internal optical material for transmitting infrared or other optical information according to embodiments herein.

FIG. 8B provides a section view of an alternative embodiment of FIG. 8 in which the melt sensor pin is comprised of an optical material according to embodiments herein.

FIG. 9A provides a schematic for a method for sensing one or more states for a material being processed according to embodiments herein.

FIG. 9B is an example diagram illustrating monitoring attributes of a material in a flowchart and adjusting flow control to dispense material at a desired target rate to fabricate a 3D printed object according to embodiments herein.

FIG. 10 provides dynamic pressure data for characterizing the viscosity of a material being processed according to embodiments herein.

FIG. 11 provides the viscosity model as a function of shear rate and temperature for the acquired pressure data plotted in FIG. 10 according to embodiments herein.

FIG. 12 provides the specific volume as a function of temperature and pressure for a material being processed according to embodiments herein.

FIG. 13 provides a photograph of a fixture and test part as well as a varying velocity profile used for validation of the described methods according to embodiments herein.

FIG. 14 provides a schematic for a method for controlling a material being processed based on feedback from sensed process states according to embodiments herein.

FIG. 15 provides acquired process states and resulting control signals for the validation part and varying flow rates of FIG. 13 according to the method of FIG. 14 and an apparatus implemented according to the embodiments of FIGS. 7 and 8 according to embodiments herein.

FIG. 16 provides contour plots for the measured part thicknesses for the validation part and varying velocity profiles of FIG. 13 produced by conventional 3D printing as well as the methods of FIGS. 14 and 17 according to embodiments herein.

FIG. 17 provides a schematic for a method for controlling a material being processed based on feedback from simulated process states according to embodiments herein.

FIG. 17A is an example diagram illustrating simulation and generation of fabrication instructions to implement on replica printing systems according to embodiments herein.

FIG. 18 provides a vector drawing of the simulated road for the validation part shown in FIG. 13 according to embodiments herein.

FIG. 19 provides a vector drawing of the simulated roads for a benchmark part as well as images of the printed part shown surface asperities according to embodiments herein.

FIG. 20 provides simulated process stated, resulting control signals, and resulting acquired melt pressure for the validation part of FIG. 13 according to the method of FIG. 17 and an apparatus implemented according to the embodiments of FIGS. 7 and 8 according to embodiments herein.

FIG. 21 provides images of a benchmark part printed with conventional machine instructions as well as a benchmark part printed with the corrected machine instructions according to the method of FIG. 17 according to embodiments herein.

FIG. 22 provides illustrative figures of merit for the simulated process of the benchmark print corresponding to FIG. 19 according to embodiments herein.

FIG. 23 provides a general method for combining the invented apparatus with the invented process control method and the invented simulation method according to embodiments herein.

FIG. 24 is an example diagram illustrating example computer architecture operable to execute one or more operations according to embodiments herein.

FIG. 25 is an example diagram illustrating pressure of material in a print nozzle versus time according to embodiments herein.

FIG. 26 is an example diagram illustrating pressure of material in a print nozzle versus time according to embodiments herein.

FIG. 27 is an example diagram illustrating an image of the printed cross section with print representing the observed print corresponding to the acquired nozzle pressure plotted in FIG. 26.

FIG. 28 is an example diagram illustrating the control actions for modeled road width as a function of the print position adjacent and through a slow section according to embodiments herein.

The foregoing and other objects, features, and advantages of the invention will be apparent from the following more particular description of preferred embodiments herein, as illustrated in the accompanying drawings in which like reference characters refer to the same parts throughout the different views. The drawings are not necessarily to scale, with emphasis instead being placed upon illustrating the embodiments, principles, concepts, etc.

### DETAILED DESCRIPTION

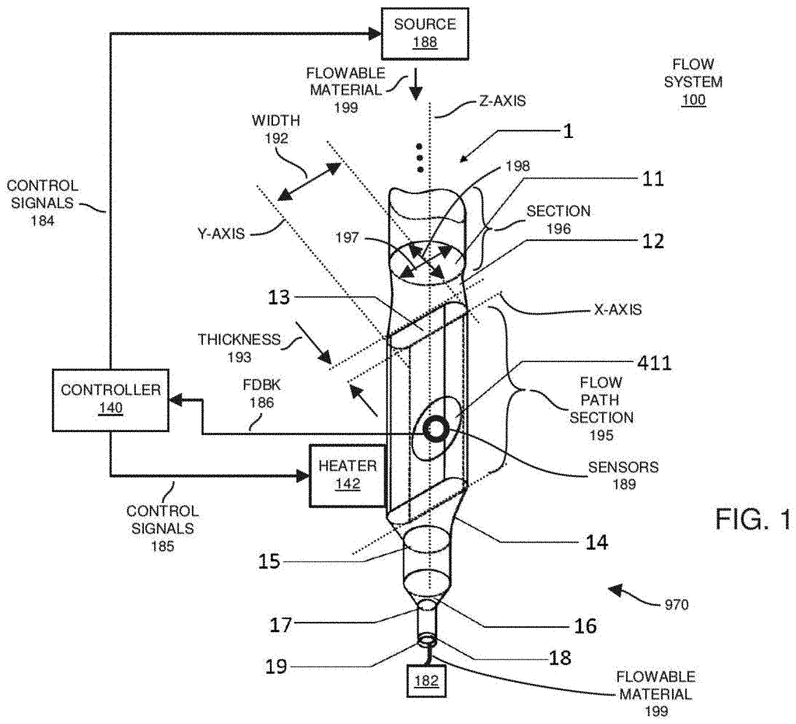

FIG. 1 depicts an exemplary embodiment of a flow system 100 including the novel melt channel 1 such as a conduit including a flow path section 195. A filament or other feedstock having a generally circular cross-section 11 is driven into a heated apparatus. A loft 12 (loft section) transitions the feedstock (section) from the circular section 11 to a section 13 (such as flow channel 195, oblong cross section) that is wider and thinner than the diameter at cross-section 11 (inlet). Loft 12 provides conduit coupling between section 196 to the flow channel 195.

In the illustrated embodiment of FIG. 1, the diameter (such as dimension 197 or dimension 198) of the inlet (such as at section 11) to the apparatus is approximately 2 mm (or other suitable value) to receiving a filament diameter that is nominally 1.75 mm (or other suitable value). The wider and thinner section (flow channel 195) is configured as a rounded or squared slot having a thickness 193 of 1 mm (or other suitable value) and an overall width 192 of 4 mm (or other suitable value).

In one embodiment, the wider and thinner section (i.e., flow channel 195) has rounded edges to ease manufacture and avoid flow stagnations during use. While the shape of the melt channel shown in FIG. 1 is implemented, other geometric sections may be preferable for various applications.

In accordance with further example embodiments, the thickness 193 of the opening associated with flow channel 195 is 50% or less of the opening as indicated by dimension 198 associated with inlet cross section 11.

For example, an ellipsoidal or oblong section (flow channel 195) will tend to provide more uniform flow across the section 13 while an even wider and thinner rectangular section will tend to provide increased surface area and improved heat transfer. In application, the dimensions of cross section 13 (i.e., cross section of the input of flow channel 195) can be selected to balance heat transfer and pressure drop requirements.

The length of the loft 12 (providing connectivity of conduit section 196 to the flow channel 195) shown in FIG. 1 is approximately equal to the diameter of the circular cross section 11 but other lengths have also been tested as later shown. Generally, lengths between one-half to five times the diameter 197 of the circular cross section 11 are preferred.

The thickness 192 of the flow channel 195 having the wider and thinner section 13 may also vary, such as between one-half and five times the diameter 197 of the circular cross section 11. In FIG. 1, the length of wider and thinner cross section 13 is approximately 2.5 times the diameter of the circular cross-section 11. Generally, the thickness 192 of cross section 13 will be equal to or greater than its width 193 in order to accommodate the inclusion of a sensor (sensing element) through or at port 411 as later described in further detail. Longer lengths (192) of cross section 13 will tend to promote greater heat conduction from the surrounding hot end and thus more uniform melt temperature but at the risk of incurring greater pressure drop.

As further shown, the melt channel 1 may then transition from wider and thinner section 13 (flow channel 195) back to a circular cross section 15 at the outlet via a loft 14. In one non-limiting example embodiment, the diameter of the circular section 15 is 1.75 mm, though other diameters may be selected such as a diameter equal to the nozzle diameter 17 as subsequently described. In one embodiment, the length of the loft 14 along the flow path along the Z-axis is approximately equal to the diameter of the circular cross-section 15, though the length may vary with quantities between one-fourth and four times the diameter of the circular section 15 being generally preferred.

In still further embodiments, as further shown in FIG. 1, flow system 100 can be configured to include one or more sensors 189 (such as pressure sensors, temperature sensors, optical sensors, etc.) disposed at, near, or through port 411 (such as opening in the wall of flow channel 195). Controller 140 controls (via simulation or based on feedback 186) a flow of the flowable material 199 into and through the fluid pathway along z-axis from source 188 (supplying the flowable material 188) to melt channel 1 and outputted from the nozzle office 19.

In one embodiment, the material 199 receive at the inlet is a solid or liquid. It is possible that the material 199 cools and is no longer flowable.

In one embodiment, controller 140 receives feedback 186 from the one or more sensors 189 and produces respective control signals 184 and 185 to control dispensing of flowable material 199 from the nozzle orifice 19 (opening).

In accordance with further example embodiments, the flowable material 199 dispensed from the nozzle orifice is used for 3D printing of a respective object 182. Control signals 184 control flow of flowable material 199 from the source 188 into the melt channel 1 (conduit). The control signals 184 control any suitable one or more parameters such as rate of flowable material 199 flowing into and through the melt channel 1, temperature of the flowable material 199 flowing into and through the melt channel 1, pressure of flowable material 199 flowing into and through the melt channel 1, pressure of flowable material 199 passing through the flow channel 195 as detected by sensors 189, etc.

In accordance with further example embodiments, the control signals 185 produced by the controller 140 control a temperature of the flowable material 199 disposed in the flow channel 195 or the temperature of the flow channel 195 itself. For example, via feedback 186 such as temperature from the sensors 189, the controller 140 detects a current temperature of the flowable material 199 in flow channel 195 and then produces controls signals 185 applied to heater 142. The control signals 185 control a corresponding temperature of the flowable material 199 passing through the flow channel 195.

In accordance with further example embodiments, the controller 140 controls movement of the assembly in which the melt channel 1 resides to produce a respective object 182. Further embodiments herein include fabrication of the object 182 as a three-dimensional part via a process of additive printing from flowable material 199 outputted from the nozzle orifice 19.

As further discussed herein, note that the implementation of sensors and receipt of feedback 186 is optional. In this latter embodiment, the controller 140 performs a respective simulation to estimate the state of the flowable material 199 in the flow channel 195 without receiving any feedback 186 from sensors 189. Based on the simulation and corresponding estimated states, the controller 140 controls a respective flow and attributes (such as temperature, pressure, output velocity, etc.) of the flowable material 199 of the flow system 100 to produce one or more objects 182.

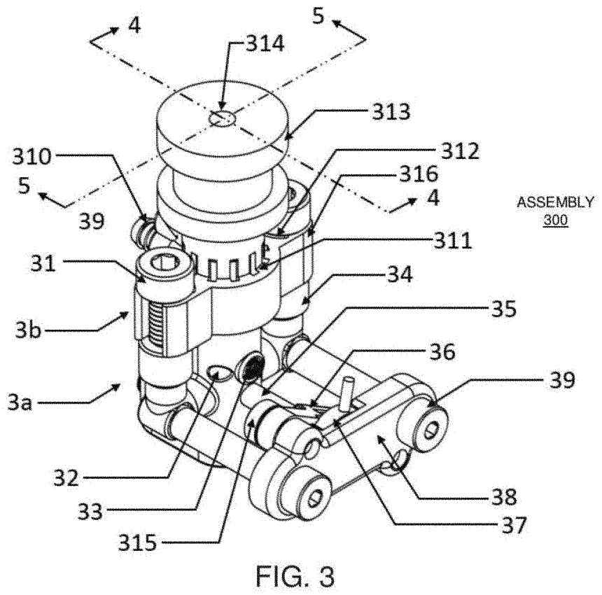

As shown in later embodiments such as FIG. 3, this the diameter of this circular cross-section 15 can correspond to the flow bore of a standard nozzle tip that includes a conical section 16 that converges to a circular cross-section 17.

In the embodiment of FIG. 1, the included angle of the conical section is 90 degrees and the diameter of the circular cross-section 17 is 0.4 mm. The length of the cylindrical flow channel having the circular cross-section section 17 is 1.2 mm, though lengths may vary with a preferred quantity generally being between one half and ten times the diameter of the circular cross-section 17.

As further shown, FIG. 1 also depicts an optional advantageous choke 18 disposed upstream prior to the nozzle orifice 19. In one embodiment, the choke includes a converging flow channel section followed by a diverging flow channel section. In FIG. 1, the flow channel converges with a taper angle of 45 degrees to a diameter of 0.3 mm. The flow channel then diverges with a taper angle of 45 degrees to a diameter of 0.4 mm at the nozzle orifice 19. These angles and diameters vary depending on the embodiment.

During 3D printing via use of the apparatus of FIG. 1, the presence of the choke 18 reduces undesirable drool when the filament is slightly retracted. The volume of the melt channel below the choke point with diameter of 0.4 mm and the nozzle orifice is on the order of 0.03 cubic millimeters. Accordingly, the choke 18 does not significantly affect the printing or resolution of the printed part but can reduce undesirable drool and thus improve the quality and consistency of the printed part. The presence and design of the choke 18 can vary by application requirements as known, for example, in thermal gate designs for hot runners as described in “Kazmer, D. O., 2016. Injection mold design engineering. Carl Hanser Verlag GmbH Co KG.”

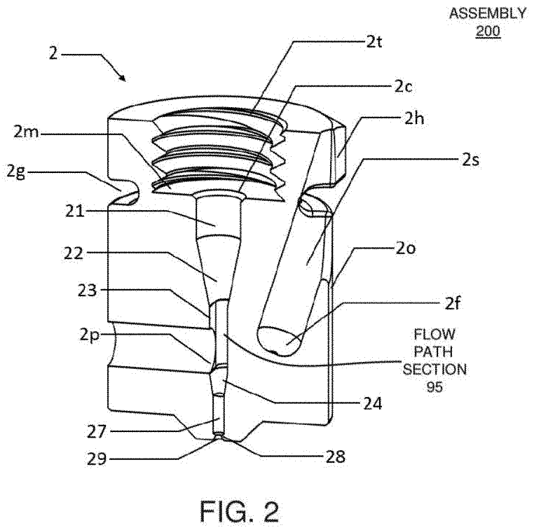

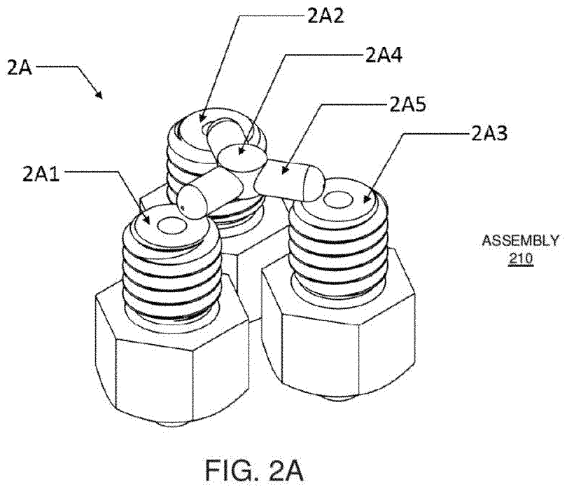

Note further that the flow channel geometry of FIG. 1 may vary with respect to its design and implementation in varying apparatus. For example, the design of FIG. 2 provides a compact hot end design with an integrated nozzle tip, such that the design is not much larger than a conventional nozzle tip. Alternatively, the design of FIGS. 3-9 dispose the flow channel geometry of FIG. 1 in hot ends for use with conventional nozzle tips. The primary advantages of the integral design of FIG. 2 include greater compactness and lower cost. Meanwhile, the primary advantages of alternative designs of FIGS. 3-9 is that standard nozzle tips may used and be readily replaced to vary the nominal dimension of the extrudate or repair damage to the nozzle tip.

Further describing the design of FIG. 2 (illustrating an apparatus such as assembly 200), the melt flow channel (flow pathway) is provided by circular bore 21 transitioning via loft 22 to a wider and thinner section 23 (a.k.a., flow channel 195 as previously discussed). After the wider and thinner section, the melt flow channel transitions via loft 24 to a circular bore 27. It is noted that the described melt channel omits the entirety of the intermediate cylindrical section with circular cross-section 15 shown in FIG. 1. Instead, the loft 14 can directly transition from circular cross-section 15 to the nozzle orifice diameter 17. Such a design is advantageous since it reduces the pressure drop that is otherwise associated with a longer flow channel as well as the volume of the compressible fluid residing within a larger flow channel.

The design of FIG. 2 is compact and backwards compatible with many 3D printer designs for retrofitting purposes. In one embodiment, this embodiment is engaged to an upstream heat break via standard M6 threads in tapped hole 2t. This design incorporates a hexagonal nut 2h external the threads having a width of 10 mm for fastening the hot end design 2 to the heat break via a wrench or similar means until the bottom surface of the heat brake engages with the mating surface 2m of the hot end. A gap 2g is provided between the nut portion 2h and the outer surface 2o of the hot end to reduce the heat flow from the hot end to the heat brake. In this design, the gap is 1.2 mm high and begins 3.6 mm from the centerline of the hot end, leaving a wall thickness of 0.6 mm between the innermost portion of gap 2g and the outermost portion of mating surface 2m. Fillets are provided on gap 2g in order to ease production of the hot end design while avoiding stress concentrations. These details, of course, are readily varied according to application requirements.

The hot end design 2 in FIG. 2 includes the flow channel features discussed with respect to FIG. 1. The cylindrical bore 21 is designed here with a diameter of 2 mm in order to receive filaments around 1.75 mm in diameter. A chamfer 2c is provided on the mating surface 2c to assist in loading of the filament from the heat break. The loft 22 then transitions to a wider and thinner section 23. In this hot end design 2, the wider and thinner section 23 has an overall length of 2.8 mm and a thickness of 0.8 mm. The flow channel then transitions via loft 24 to a cylindrical section 27 having a bore of 0.6 mm. A choke 28 is provided leading to a nozzle orifice 29 having a diameter of 0.5 mm. A benefit of this particular flow channel geometry is that the down stream channels get both narrower and thinner down the length of the flow channel in the direction from the inlet 21 to the choke 28 of the nozzle orifice 29. This converging flow channel geometry also allows the processed material to be removed from above when cooled.

As previously indicated, the hot end design incorporates all features of the nozzle tip despite the fact that the hot end design 2 is itself not much larger than a standard nozzle tip. Compared to traditional hot ends, the hot end design 2 provides not only shorter flow length, lower pressure drop, and less retained melt volume but also a shorter overall height such that larger components can be made on a printer when the hot end design 2 replaces a larger hot end design.

The hot end design 2 uses a cylindrical heater band (such as heater 142) that mates with outer surface 2o. In this design, the heater band has a length and inner diameter of 10 mm and may be fasten to outer surface 2o using a hose clamp or similar tightening mechanism. The hexagonal portions 2h provide a natural stop for locating the heater band. For temperature sensing, an inclined bore 2s having a diameter of 2.2 mm is provided in the body of the hot end design to receive a temperature sensor such as a thermistor, thermocouple, etc., as described herein. A fillet 2f is provided in the bore 2s to increase the contact surface area between the body of the hot end and the sensing portion of the temperature sensor. The temperature sensor may be retained by compression of its lead wires between the surface of the bore 2s or the hexagonal portion 2h and the adjacent heater band upon securing the heater band to the outer surface 2o.

The design of FIG. 2 is provided an optional sensing port 2p at the distal end of the wider and thinner section 23 (a.k.a., flow channel 195) wherein the proximal end of the hot end 2 corresponds to the start of the threaded engagement 2t. This optional sensing port 2p need not be provided in the design but, if provided, may be fitted with a sensor or transmission element such as subsequently described. Alternatively, the optional sensing port 2p may be provided and plugged with a solid member if the sensing means is not required.

The thermal performance of the hot end design 2 is greatly improved compared to the more conventional designs. There are several reasons. First, in one nonlimiting example embodiment, the hot end design has a much smaller volume than conventional designs. The design shown in FIG. 2 has a volume of 0.9 ml and a mass of only 7 g when made of stainless steel. When coupled to a 40 Watt heater band (such as heater 142), the time to heat the nozzle from 20 to 240 degrees Celsius is approximately 20 s (the product of the mass 7 g, specific heat 0.5 J/g C, and temperature change 220 C divided by the heating power 40 W). If an even better thermal response is desired, the design of FIG. 2 can be modified to have an outer surface diameter and length of 8 mm. The resulting mass is reduced to 4.5 g such that the heating time can be reduced to less than 10 seconds when used with a 60 W heater band.

Another reason that the thermal performance of the hot end design 2 is improved compared to prior art designs is that the heater band (142) generally surrounds the hot end. As such, the heat is more uniformly provided to the hot end and processed material than could otherwise be delivered via a heater cartridge. The heater band may also be designed with mineral insulators such that the majority of heat is directed inward to the hot end rather than being outwardly lost to the environment. The use of the gap 2g also reduces undesired heat transfer to the heat break that would otherwise have to be cooled. While this embodiment uses a heater band (142) mated to an outer circular surface, other embodiments use heater cartridges mated to internal bores. It is possible and advantageous to combine certain inventive features across the embodiments along with other elements known in the prior art. For example, the shape of the outer surface of the embodiment shown in FIG. 2 may be designed as a rectangular shape and fitted with a strip heater or other heating elements.

Most importantly, the wider and thinner cross section (flow channel 195) allows the more rapid heating of the feedstock material being processed. Thermal analysis may be applied such as described by the inventor in the chapter “Cooling System Design” of his book “Injection mold design engineering, 2nd edition” published by Carl Hanser Verlag GmbH Co KG in 2016. As an example, suppose that the controlled hot end temperature is 300 degrees Celsius, incoming feedstock temperature is 50 degrees Celsius, and the minimum output feedstock temperature is 290 degrees Celsius. The approximate heating time for a 1.75 mm circular filament would be 0.12 seconds. By comparison, transitioning the melt channel 1 to a slot at flow channel 195 with a thickness 193 of 0.8 mm reduces the heating time to less than 0.06 seconds. As such, significantly higher volumetric flow rates can be achieved while delivering the processed material (flowable material 199) at desired melt temperatures.

There are many ways to produce the hot end design of FIG. 2 including machining, casting, additive manufacturing, and others including combinations thereof. A preferred manufacturing process is casting of bronze and brass hot ends from a pattern such as shown in FIG. 2A (illustrating an apparatus such as assembly 210). In such a method, the pattern 2A can include hot ends 2A1 and 2A2 and 2A3 that are connected to sprue 2A4 and runners 2A5. The cast runner system (comprised of 2A4 and 2A5) can be disconnected from the hot ends and each proximal face the hot ends finished to a planar surface milling or grinding or turning.

While investment casting of a 3D printed pattern is a preferred process for producing the described hot end designs, hot ends have been directly produced by additive manufacturing of aluminum, steel, and titanium with processes including direct metal laser sintering and binder jetting. These processes tend to be lower cost than investment casting but also to provide rougher surfaces. A preferred process high-detail binder jetting of high-grade stainless steel (316L) offered by Materialise NV (Leuven, Belgium), which provides very good surface quality, resolution, and a significant level of detail. When needed, finishing of the sensor ports, threads, and flow channels is provided by machining.

An isometric view of a third embodiment of the instrumented hot end is provided in FIG. 3. Component 3a is a hot end configured to mate with an extruder adaptor 3b via two socket head cap screws 31. This embodiment provides many inventive features that may optionally be incorporated into this and other hot end and extruder adaptor designs. The temperature of the hot end is controlled in response to a melt temperature sensor (not shown) inserted into bore 32 and retained with set screw (not shown) into threaded hole 33.

One inventive feature is the incorporation of melt sensing at the location of the wider and thinner section (flow channel 195) of the flow channel (a.k.a., conduit) as shown in previous embodiments and later figures for this embodiment. The use of the wider and thinner section provides the additional benefit of accommodating a relatively large melt sensor having a flat sensing face without disturbing the flow of the processed feedstock such as is common in flow channels having a circular cross-section. While a rectangular or rounded rectangular wider and thinner cross-section is preferred, the disclosed melt sensing means can function with ellipsoidal and circular sections.

In typical applications, the sensing head is threaded into the apparatus housing the flow channels such that the sensing head directly contacts the processed material. The inventor has developed sensors for monitoring melt pressure such as described by “Gordon, Guthrie, David O. Kazmer, Xinyao Tang, Zhoayan Fan, and Robert X. Gao. Quality control using a multivariate injection molding sensor. The International Journal of Advanced Manufacturing Technology 78, no. 9-12 (2015): 1381-1391.” The inventor has also developed a melt sensor for use in 3D printing, e.g. “Coogan, T. J. and Kazmer, D. O., 2019. In-line rheological monitoring of fused deposition modeling. Journal of Rheology, 63(1), pp. 141-155.” While the latter sensor functioned well, its use of cantilever load cell attached to an outrigger design connected to the nozzle tip was found to be insufficiently robust for broad application. Higher melt pressures were found to cause excessive displacement damaging the load cell and allowing the material being processed to escape from the melt sensor's access port in the apparatus. Compared to the prior work of Coogan and Kazmer, the design of FIG. 3 (illustrating an apparatus such as assembly 300) has multiple novel features. First, the load cell is not supported by the nozzle tip such that higher mechanical stiffness and load bearing capacity are provided. Second, it is located in a melt channel having a wider and thinner section so that it does not interrupt the flow of the processed material.

In the described embodiment, the melt sensor pin 35 (such as one of sensors 189) is supported by a button-style load cell 37 that is supported by a backing plate 38. The backing plate 38 is connected back to the hot end's two arms 34 via shoulder bolts 39. The melt sensor pin 35 represents a generic sensing element. The melt sensor pin as a generic sensing element may be transmission media for conveying the process state such as stress indicative of pressure, heat indicative of temperature, or radiation indicative of material temperature or composition. Alternatively, the melt sensor pin 35 as a sensing element may be a sensor in which the process state such as pressure, temperature, or material composition is directly converted into a signal suitable for process monitoring and control purposes.

The design of FIG. 3 provides excellent control of the position of the backing plate relative to the plane of the flow channel in the hot end 3a. The shoulder bolts, backing plate, and load sensor are all very stiff, allowing for very fast melt sensing without significant displacement. The melt sensor pin 35 is retained via a cover 36 fastened to the backing plate 38 via two socket head cap screws 315.

The design and operation of the melt sensor pin 35 will be described in more detail subsequently. First, some of the other external features are introduced. The extruder adaptor 3b is configured to be interchangeable with other extruders currently commercially available such as the E3D Titan and related models. A shoulder bushing 313 is sized to engage a slot in the extruder housing (not shown). Other designs are readily configured for adapting the hot end 3a to an extruder such as a threaded engagement or mounting with screws. Furthermore, it is recognized that the hot end design 3a can be modified to provide thermal management so that it can be directly mounted to an extruder without the intervening extruder adaptor 3b that provides cooling.

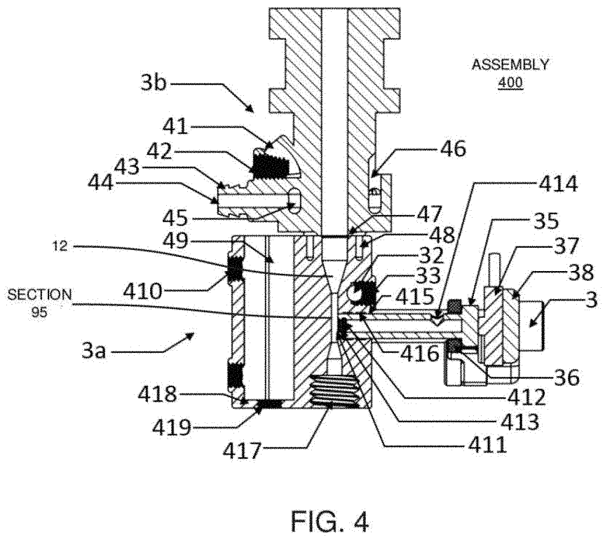

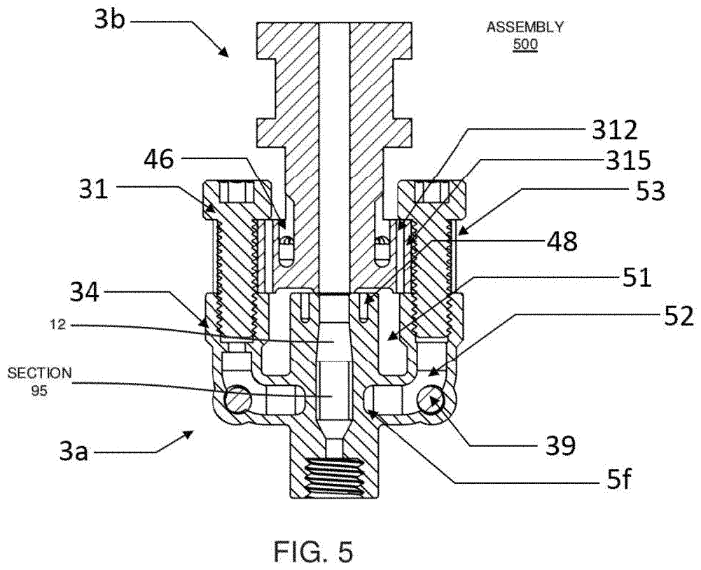

With regard to cooling, this embodiment provides many inventive features. For example, the adaptor 3b includes a barbed tube fitting 310 for receiving cooled air via a delivery tube (not shown). An internal air flow manifold (later shown) delivers cooled air to multiple cooling channels 311 disposed around the circumference of the adaptor. To reduce the need for cooling, the design incorporates multiple insulating features. For example, slots 312 are provided between each of the outer arms 316 of the adaptor 3b and the internal air flow manifold to reduce heat transfer from the socket head cap screws 31 that are connect the adaptor 3b to the hot end 3a. Additional insulating features will be subsequently discussed with respect to FIG. 4 and FIG. 5 that are sections taken in the directions indicated to arrows 4-4 and 5-5, respectively, that are shown in FIG. 3.

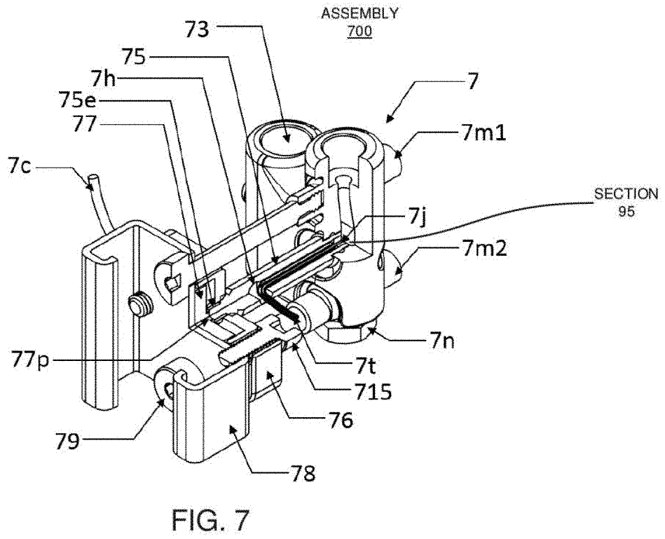

FIG. 4 (illustrating an apparatus such as assembly 400) provides a cross-section through the melt sensor pin 35. The pin may be solid to transmit the stress from the melt pressure applied at face 411 through the pin 35 to the button-style load cell 37. In this design, however, the melt pressure pin has a bore such that a melt temperature sensing element 413 is disposed at the face of the pin 35 proximal to the melt channel at face 411. The internal bore may be provided with an annular groove 412 to assist in fastening to the melt temperature sensing element to the pin 35. In a preferred embodiment, the melt sensor (such as one of sensors 189) is a type J thermocouple (not shown, but later detailed in FIG. 7) soldered or brazed or welded to the side walls of the internal bore of pin 35. Other designs are possible including non-insulated thermocouples with a sensing junction protruding into the melt stream. The melt temperature sensor's lead wires (later detailed in FIG. 7) are routed through side hole 414.

As shown, the melt sensor pin 35 is disposed in a cylindrical bore 415 in the hot end 3a providing access to the internal melt channel at face 411. The location of the cylindrical bore 415 is biased away from the inlet and towards the outlet of the hot end. The reason is that this biasing is doubly beneficial in that the biasing not only ensures that the material is closer to a steady state temperature but also the biasing will tend to reduce the pressure drop between the melt sensor pin and the nozzle outlet. The diameter of the melt sensor pin and cylindrical bore are designed to a locational clearance fit with a hole basis H7/h6 according to ANSI/ASMEB4.2 (R2009). In this example, the diameter of the cylindrical bore 415 is nominally 3.000 mm with a tolerance range of [3.000,3.010] while the diameter of the melt sensor pin 35 has a tolerance range of [2.994,3.000] mm. This fit provides a sufficient seal to avoid leakage of the melt during operation. To provide for improved lubrication of the pin, annular grooves 416 are provided in the hot end 3a prior to final reaming and finishing of the bore 415.

The melt channel (flow channel 195) in hot end 3a follows the design as previously disclosed for an inlet filament of 2.85 mm. The melt channel from top to bottom of FIG. 4 consists of a chamfered cylindrical inlet (such as section 12) transitioning to a rounded rectangular section (such as flow channel 195) via an upper loft section 12. In one embodiment, the rounded rectangular section has a width of 3.8 mm with a flat section of 3.0 mm to present the internal melt channel face 411 to the melt sensor pin 35. The length of the channel having a wider and thinner section (flow channel 195) is approximately 5 mm, after which the melt channel transitions via a lower loft section to a cylindrical outlet having a nominal diameter of 1.75 mm. A nozzle tip, such as one having a 1.75 mm circular inlet, can be inserted into the hot end 3a via threads 417. In this design, the threads 417 are a standard M6.

As previously introduced, this embodiment has several features to manage heat transfer. The bore 49 for housing the heater cartridge (such as heater 142) is not quite circular, but rather a slot having a width of 6.1 mm (corresponding to the direction into/out of the plane of FIG. 4) and a length of 7 mm (corresponding to the direction from left to right in FIG. 4). The greater length allows a heater cartridge having a diameter of 6 mm and a length of 20 mm to be inserted into the bore 49 and secured via set screws (not shown) used with into threaded holes 410. This design allows the secure fastening of the heater cartridge in the bore while also advantageously biasing the majority of the heat transfer in the direction of the melt channel. The bore 49 for the heater cartridge is designed as a blind hole with a bottom wall 418. A set screw can be inserted into the threaded hole 419 in the bottom wall and used as a seal for the bore as well as a jack screw for removing the heater cartridge if needed. The presence of the bottom wall ensures that the heater cartridge does not protrude below the bottom surface of the hot end 3a while also being protected from molten material. The threads for the set screws used in threaded holes 33, 35, 410, 415, and 419 are all specified as M3. Of course, different designs can be used according to various application requirements. For example, cap screws can be used with holes 410 to fasten an insulating enclosure (not shown) about the entirety of the hot end to reduce heat transfer and further protect the hot end from abuse.

The heat transfer from the hot end 3a and the extruder adaptor is further minimized in additional ways. As previously described the arms 316 of the adaptor 3b were provided with slots 312 to reduce heat transfer. A circular slot 48 is also provided at the top of the hot end 3a to reduce heat transfer from the hot end 3a to the protrusion 47 on the bottom of the adaptor 3b. The protrusion 47 is designed to have a minimal wall thickness to minimize the contact surface area between the hot end 3a and extruder adaptor 3b at this location. In this design, the protrusion 47 has a width of 0.6 mm and a height of 0.5 mm tapering outwards at a 45 degree angle. The bottom surface of the protrusion 47 is nominally in the same plane as the bottom surface of the arms 316 such that there are not excessive compressive stresses. In practice, the system is quite forgiving to variations in planarity and surface roughness. The reason is that the arms 34 of the hot end 3a and the arms 316 of the adaptor 3b are somewhat compliant. As such, tightening of the screws 31 to secure to the adaptor 3b to the hot end 3a results in an adequate seal without excessive stresses being placed on protrusion 47.

FIG. 4 also provides additional insights into the cooling of the extruder adaptor 3b. In this design, pressurized cooling air or another suitable substance such as nitrogen is introduced into bore 44 through a tube that can be secured to barbs 43. In this design, the inner diameter of the tube is 0.125 inches. The air flows through an annular manifold 45 and out a cooling channel 46. The presence of the annular manifold not only serves to cool the extruder adaptor but also provides another insulating space to minimize heat transfer from the bottom portion of the adaptor 3b that is in contact with the hot end 3a to the upper portion of the adaptor 3b that is in contact with other portions of the apparatus (not shown) that may not be designed to endure elevated temperatures. The flow of a cooling fluid into the bore 44 may be optionally controlled in response to a temperature sensor (not shown) inserted into bore 41 and secured by a set screw (not shown) that is inserted into threaded hole 42.

FIG. 5 (illustrating an apparatus such as assembly 500) shows a cross-section normal to the cross-section of FIG. 4 along the center-line of the melt channel, such that the view is away from the sensing apparatus. Various features from the prior embodiments are indicated to orient the practitioner relative to the features disclosed in FIG. 3 and FIG. 4. The arms 34 of the hot end 3b are separated from the central portion of the hot end 3a by an intervening space 51. This intervening space 51 prevents the direct heat transfer from the central portion that is close to the heater cartridge (heater 142) to the arms 34 and thereto the screws 31 to the arms 316 to the upper portion of the extruder adaptor 3b.

To further reduce heat transfer, the connecting arms 34 of the hot end are designed to be hollow. The internal cavity 52 of each arm is formed as a curved sweep having a diameter of 3 mm. The wall thickness of the arms is 1 mm, reducing the amount of heat transfer to both the shoulder bolts 39 (and thus the button-style load sensor) as well as the to the upper portion of the arms in a manner similar to the intervening space 51. To provide access for the screws 31 as well as to reduce heat transfer between the hot end 3a and the extruder adaptor 3b, the arms 316 are open ended with a provided space 53.

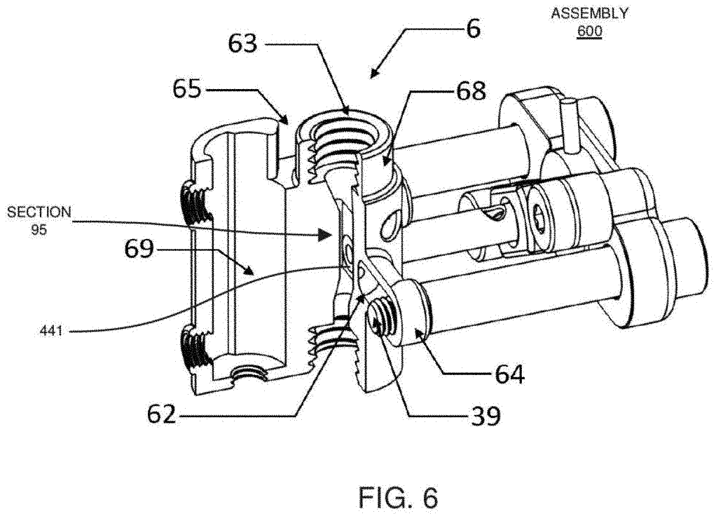

FIG. 6 (illustrating an apparatus such as assembly 600) depicts another embodiment of an instrumented hot end that can be used with a threaded nozzle as well as a threaded heat break; a rectangular cut has been provided to enhance visibility of certain inventive features. To interface with a standard heat break, an upper hole 63 has been provided with M6 threads. To reduce heat transfer from the hot end, the material adjacent the bore 69 housing a heater cartridge to the extruder adaptor has been removed to provide a space 65. This space 65 forces the heat to flow down into the central portion of the hot end with relatively little heat transfer going to the extruder adaptor due to the relatively thin wall around the hole 63. In this design, the outer diameter of the protrusion 68 is 7.6 mm such that the minimum wall thickness between the outermost surface of the M6 thread and the outside of the boss is 0.8 mm.

As shown in FIG. 6, the arms 64 do not have an upper region but retain their inner cavities 62 in order to reduce heat transfer from the central portion of the hot end 6 to the shoulder bolts 39. While the cavities 62 provide a hole on one side of the threaded hole in the side arms 64, there is sufficient retained thread for the shoulder bolt to provide secure fastening of the back plate and sensor components.

As previously described, the embodiments were designed to be produced by direct metal laser sintering and binder jet manufacturing. We have found that these processes can support feature size of 0.1-0.3 mm and minimum wall thicknesses of 0.3-0.8 mm. Generally, the disclosed embodiments were typically designed with a minimum wall thickness of 0.8 mm. In some case, such as the protrusion 47 in the extruder adaptor 3b of FIG. 4, the wall thickness was only 0.5 mm. However, the adjacent chamfer to protrusion 47 has a diverging angle of 45 degrees that allows this thin protrusion to be reliably produced. Wall thicknesses of 0.6 mm have also been found to be quite robust when provided with a fillet at intersections with adjoining walls. Many of the embodiments have threaded features including M3 and M6 threads. While the additive manufacturing process does not directly produce usable threads, reliable threads may be created by tapping a bore provided by the additive manufacturing process. Similarly with regard to tolerances and surface roughness, finish machining of critical features (nozzle orifice and mating surfaces between the melt sensor pin and mating bore in the hot end) was sometimes applied. When finish machining is planned, designs were made to be steel safe wherein surplus metal stock is provided by additive manufacturing that is removed during finishing.

The embodiments were also found to be successfully made from investment casting in brass and bronze using patterns of the designs printed from a stereolithography type process; surface finishes were excellent such that little finish machining is required. The embodiments with a minimum wall thickness of 0.8 mm were found to be successfully made from direct metal laser sintering (DMLS) of aluminum (such as AlSi10Mg), which is a strong, low weight material with good thermal properties. The DMLS process provides acceptable feature creation albeit with rough surfaces that can require additional finishing than the binder jet and casting processes. Of these processes, the binder jet process was preferred followed by casting. The operating temperatures of binder jet steel were also the highest, with service temperatures well above 500 degrees Celsius such that it is capable of process engineering thermoplastic materials such as PEEK (polyetheretherketone) and PTFE (polytetrafluoroethylene) as well as solders and other eutectic metals.

The provided button-style load sensor 37 is a subminiature industrial compression load cell such as Omega LCKD-50 with a 50 lb (222 N) load capacity, maximum load of 150 lb, repeatability within 0.1% full scale output, operating range to 121 degrees Celsius, and a thermal drift of 0.018% per degree Celsius. The thermal drift may be somewhat compensated by incorporating a temperature sensor (such as one of sensors 189) in the backing plate 38 and providing a correction in the signal conditioning or process control system (such as controller 140). For this load cell and the 3 mm diameter sensor pin 35, the maximum sensed pressure is 31 MPa with a maximum pressure before failure equal to 94 MPa. By comparison, prior testing has indicated melt pressures typically on the order of 10 MPa. The excitation signal is 5 V with an output of 2 mV/V for full scale output. As such, a 10 MPa signal would correspond to one third of the full scale output, such that a 5 V excitation voltage would yield an output of 3.33 mV. A data acquisition system can collect the sensor data directly or acquire the data after optional amplification and filtering from a signal conditioner.

FIG. 7 (illustrating an apparatus such as assembly 700) provides a cut isometric view of an embodiment used for validation and characterization as well as part production (one or more object 182) by 3d printing. In FIG. 7, the support plate 78 is implemented using an aluminum extrusion, specifically a low profile strut channel (McMaster part number 1259N119). This channel was found to be very light while also providing sufficient stiffness and excellent heat transfer for cooling of the load cell 77. The implemented load cell was a Aloce GB/T7561-2009 with a rated load capacity of 10 kgf, compensated temperature range of −10 to 60 C, operating temperature range of −20 to 80 C, comprehensive error less than 0.1% of full scale load, and creep less than 0.05% of full scale load across 30 minutes. The output signal is provided by load cell cable 7c which also provides an excitation signal to the load cell. In this embodiment, a 5 VDC excitation was used with a rated output of 0.91088 mV/V.

Melt sensor pin 75 (such as one of sensors 189) may be provided with an axial bore as shown to accommodate a thermocouple 7t that is inserted through a thru hole 7h that is normal to the axis of the melt sensor pin. Thermocouples of type J and K are generally preferred though other thermocouple types and melt sensing means may also be used. The thermocouple's conductors terminate at a hot junction 7j where they are soldered, brazed, or welded to the bore of the melt sensor pin proximal to the melt channel of the apparatus. A preferred solder in Sn20/Au80, which provides high tensile strength and conductivities with an upper use temperature approaching 280 C. For higher temperature applications, a brazing material such as Ag72/Cu28 may be used. The front surface of the melt sensor pin assembly may then be machined or polished to provide a surface that is flush with the proximal surface of the wider and thinner section (flow channel 195) of the melt channel. The voltage difference across the leads of the conductors of the thermocouple 7t may then be acquired, preferably with cold junction compensation, to estimate the temperature of the material being processed. The responsivity of this temperature sensing means is limited by the heat conduction from the thermocouple junction to the surrounding body of the apparatus but known to provide a useful estimate of the temperature. To reduce heat conduction and improve sensor responsivity, the hot junction 7j or outside surface of the melt sensor pin may be provided an insulating layer to reduce heat transfer to the surrounding body of the apparatus.

The through hole 7h in the melt sensor pin 75 not only provides access for the melt sensing means 7t but also reduces heat transfer from the hot end to the load cell. As such, it was found to provide one or more through holes 7h at different axial locations to reduce heat transfer and maintain reduced temperatures of the load cell. To further reduce heat transfer, it was also found beneficial to provide a groove and reduced diameter of the melt sensor pin at the end 75e of the melt sensor proximal to the load cell. While not obvious in the drawing of FIG. 7, the protrusion 77p of the load cell 77 is provided a curved, convex surface to minimize the contact area and heat transfer between the melt sensor pin 75 and the load cell 77.

To radially locate the load cell 77 and melt sensor pin 75, a retainer 76 is provided. The retainer 76 has a cavity and through holes for containing the load cell and providing access for the melt sensor pin 75 to the load cell 77. The retainer 76 also has through holes for fasteners 715 that thread into tapped holes in the support 78. By this arrangement, the load cell can be securely housed without any stress being applied to the body of the load cell. In the physical implementation of this embodiment, the retainer was made by 3D printing from ABS and found to function without issues.

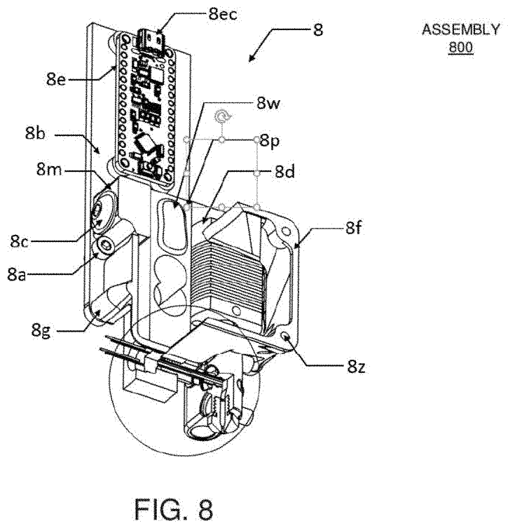

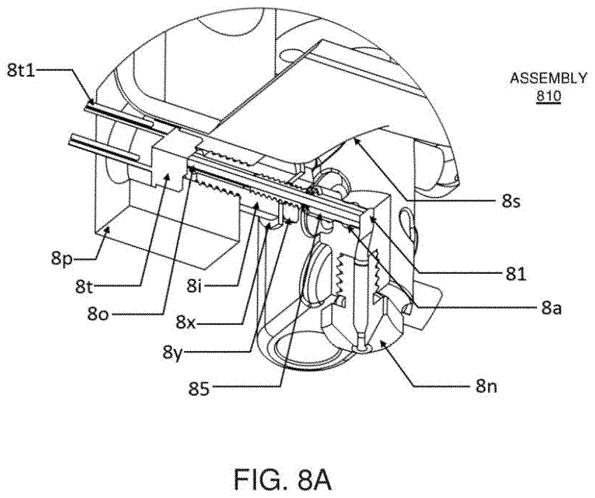

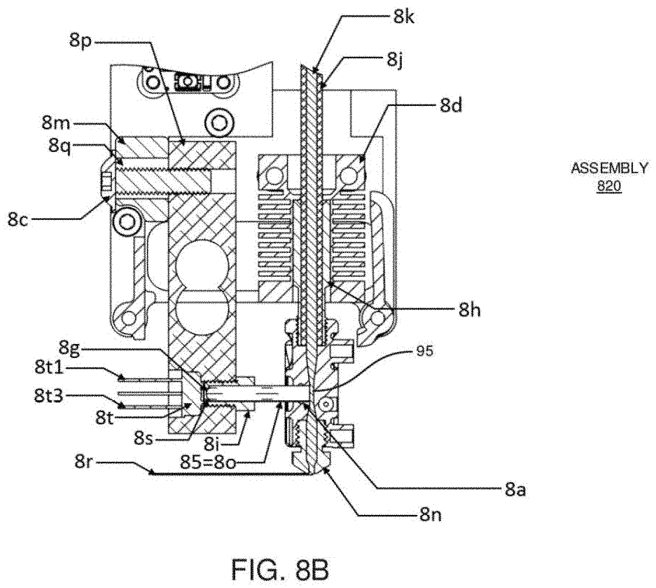

The design of FIG. 7 also provides a significant improvement relative to the designs of FIGS. 3-6. Namely, the orientation of the melt channel and sensing means is rotated 90 degrees relative to the flow direction of the material being processed. As a result, the heat from the heating element inserted into bore 73 can access both sides of the melt channel. By comparison, the melt channel of FIGS. 3-6 was rotated such that the heat transfer would tend to favor one side of the melt channel while the heat transfer to the opposite side would be somewhat limited by the heat transfer through the surrounding body of the apparatus. As such, the design of FIG. 7 (and also subsequent FIG. 8) provides not only improved heat transfer, temperature uniformity, and melting capacity but also two potential sensing ports on both sides of the wider and thinner section of the melt channel. For this reason, a second set of mounting arms 7m1 and 7m2 is provided for attachment of a different sensing means. The sensing means may provide, for example, an infrared sensor or camera to visually inspect the material being processed in situ. Alternatively, the second set of mounting arms may be used to mount auxiliary sensing or processing means such as a camera or fan, respectively.

FIG. 8 (illustrating an apparatus such as assembly 800) provides a cut isometric view of an implemented embodiment used for validation and characterization as well as part production by 3d printing. As shown in FIG. 8 and the detail view of FIG. 8A (illustrating an apparatus such as assembly 810), the orientation of the melt channel 81 is the same as previously described with respect to the melt channel of FIG. 7. The nozzle tip 8n is also shown detailing the typical connection of the nozzle tip's flow bore to the distal end of the melt channel disposed in the hot end.

The embodiment of FIG. 8 provides at least four significant differences from the embodiment shown in FIG. 7. First, the pressure sensing means 8p is not a button load cell but rather a load beam connected to mounting plate 8b via mounting feature 8m and flanged button head cap screw 8c. In this implementation, the load beam (HTC Sensor P/N TAL 220B) has a capacity of 5 kgf with a combined error of 0.05% full scale output, creep of 0.1% full scale output per 3 minutes, and an operating temperature range of −10 to 55 C. This configuration eliminates the need for shoulder bolts connecting the hot end body to the support plate as implemented for the embodiments of FIGS. 3-7. As such, heat transfer from the hot end body to the load sensor is substantially reduced. To even further reduce the heat transfer, an insulating adaptor 8i is provided between the melt sensor pin 85 and the load beam 8p. In this particular design, the insulating adaptor is machined from a quarter-inch rod of PEEK (polyether ether ketone, McMaster 8503K244) with an M3 threaded portion to connect to the melt sensor pin 85 and an M5 threaded portion to connect to the load beam 8p. The PEEK material comprising the insulating adaptor 8i has lower thermal conductivity than steel or aluminum and can withstand temperatures up to 250 degrees C.

A benefit of this configuration is that the axial location of the melt sensor pin 85 may be finely adjusted by using a lock nut 8y that engages the thread portion of the melt sensor pin. In practice, the axial location can be finely adjusted by inserting a gage pin having a diameter equal to the thickness of the wider and thinner section (a.k.a., flow channel 195) of the melt channel into the hot end while the nozzle tip is disconnected. The axial position of the melt sensor pin can be adjusted by rotating the melt sensor pin, and then secured by tightening the lock nut 8y. An oversized brass or aluminum washer 8x may be disposed between the lock nut 8y and the insulating adaptor 8i to manage stresses and improve cooling at this location.

A second significant difference between the embodiment of FIG. 8 and that of FIG. 7 is the incorporation of an infrared thermometer 8t. Given this configuration of the melt sensor pin 85 and the load beam 8p, the melt sensor pin 85 is provided with a through hole and fitted with an optical material 80 for accessing the material being processed. In this embodiment, the nominal diameter and length of a borosilicate glass rod (McMaster part number 8496K1) are 2 mm and 20 mm, respectively. To retain the glass rod within the melt sensor pin (one of sensors 189), the end of the melt sensor pin away from the melt channel may be provided a shoulder that prevents the axial displacement of the optical rod upon application of pressure on the rod's face by the material being processed in the melt channel. As an alternative to the use of a glass rod, a bundle of fiber optic fibers may be used akin to that described by “Bur, A. J., Wang, F. W., Thomas, C. L. and Rose, J. L., 1994. In-line optical monitoring of polymer injection molding. Polymer Engineering & Science, 34(8), pp. 671-679.” Specifically, a bundle of optical fibers having a diameter of 25 microns may be inserted into the 2 mm bore of the melt sensor pin with an adhesive or sealant such as a high temperature epoxy.

Given that the load carried by the melt sensor pin 85 is supported by the load beam 8p, an infrared thermometer 8t is disposed in the body of the load beam 8p to access the optical material 80. In this embodiment, the infrared thermometer 8t is implemented as an MLX90614 with an operating temperature range of −40 to 85 C and a target temperature range of −70 to 382 C. This particular infrared thermometer is a 4 conductor device with lead wires 8t1 to 8t4. This implementation has much greater measurement precision and dynamic response than the embodiment of FIG. 7 incorporating a thermocouple. Moreover, the use of the infrared sensor also provides a measurement of the ambient temperature within the load beam 8p, and thus allows for calibration of the load beam's output signal as a function of the ambient temperature. Accordingly, the precision and robustness of both the temperature and pressure measurements are improved and at relatively low cost.

The third significant difference between the embodiment of FIG. 8 and that of FIG. 7 is the incorporation of digital electronics 8e on the mounting plate 8b. The digital electronics has been implemented as an Artemis microcontroller (Sparkfun P/N DEV-16832) but may also be implemented as many other microcontrollers and semiconductor devices such as the Adafruit Metro Mini 328 (Adafruit P/N 2590) as shown in FIG. 8. The Artemis microcontroller includes an ICM-20948 device (TDK InvenSense) with a 3-axis gyroscope, 3-axis accelerometer, and 3-axis compass for motion tracking purposes. In the embodiment of FIG. 8, data from the load beam 8p and the infrared thermocouple 8t may be acquired from the digital electronics 8e. Alternatively, a motion tracking device (such as the NXP P/N FXOS8700CQR1) may optionally be mounted on the mounting plate 8b such that the position, load, and temperature data acquired by a controller that is not mounted to mounting plate 8b. This latter embodiment (not shown) has the advantage of minimizing the size and mass of the apparatus while also improving the replacement of the motion tracking device and also positioning the controller at a location that is near room temperature and more easily accessed by the end-user and other electrical systems.

A connector Sec is shown on the digital electronics for communication with a controller, computer, or other machine elements such as stepper motor drivers, relays, etc. However, the digital electronics may also communicate wirelessly such as through standard protocols such as Bluetooth, 2G, 3G, 4G, 5G, LTE, NFC, RFID, and others as well as proprietary protocols developed for communications efficiency and security.

A fourth significant difference between the embodiment of FIG. 8 and that of FIG. 7 is the inclusion of the heat break (8h in FIG. 8B), cooling block 8d and fan shroud 8f. This particular cooling block 8d is for a Creality printer such as their CR 10 or Ender 5. The heat break is approximately 27 mm in the axial direction of the filament, 22 mm wide, and 12 mm (millimeters) deep. In the implemented embodiment, the mounting plate 8b and cooling block 8d and remainder of the apparatus are attached to an Micro Swiss direct drive extruder (MatterHackers P/N MQ0866D1, not shown) that is fitted to and replaces the Bowden style drive on a Creality Ender 5. While these and other details are provided for illustrative purposes, the apparatus may be readily applied to other heat breaks, cooling blocks, extruders, and printers without experimentation. The fan shroud 8f is fitted to the mounting plate through threaded bosses 8g integrated with the fan shroud. A 40 mm fan is attached to the fan shroud via four mounting holes such as 8z on a 32 mm pitch. This particular implementation for the fan shroud 8f also includes a lofted surface 8s that directs the air flow away from the hot end and towards the cooling break 8d and the melt sensing means 8p. In this manner, higher operating temperatures may be readily achieved with less heating power while also maintaining the heat break and sensing means at lower temperatures.

FIG. 8B (illustrating an apparatus such as assembly 820) provides a section view of an alternative embodiment of FIG. 8 in which the melt sensor pin 85 (such as one of sensors 189) is comprised of an optical material 80. The optical rod may be composed of any transmitting material with desired properties such as BK 7 borosilicate glass, calcium fluoride, crystal quartz, magnesium fluoride, UV grade fused silica, and zinc selenide, and others. One example is borosilicate glass (such as McMaster P/N 8496K11) having a 3 mm diameter. The use of an optical media not only simplifies the design but also substantially reduces heat transfer from the hot end to the load cell since the optical material (such as borosilicate glass, thermal conductivity of 1.14 W/mK) has a lower thermal conductivity than metal (such as steel, thermal conductivity of 50 W/mK or brass, thermal conductivity of 109 W/mK).

The end of the melt sensor pin proximal to the material being processed may be optically ground with tight tolerances to provide a tight sliding fit as previously described for fitting the bore of the hot end. The end of the melt sensor pin proximal to the temperature sensor 8t may be provided a shoulder 8s on its outer diameter that mates with a protruding ledge on the insulator 8i to constrain the axial movement of the melt sensor pin. Alternatively, the melt sensor pin may be adhered to the insulator 8i using a press fit, adhesive, set screw, or other means. The end of the melt sensor pin proximal to the temperature sensor 8t may also be provided a lens 8g for the purpose of focusing the transmitted radiation to the detector within the temperature sensor 8t. Temperature sensor 8t can also be replaced with another transmission means such as a flexible optical fiber or bundle of optical fibers for transmitting the radiation to temperature sensor, camera, or other sensor remotely located (such as a free standing instrument or a device mounted to the frame of the printer).

FIG. 8B also provides additional details of a typical assembly including the heat break 8h connecting the hot end to the cool block 8d, a polytetrafluoroethylene (PTFE) tube 8j for insulating and directing the material being processed, the material being processed 8k, and the deposited road 8r. Also shown is a section of a slot 8q in mounting feature 8m. The slot allows the vertical position of the load cell 8p to be determined by the load sensor 8p relative to the access port of the hot end. Washers or shims, either between the insulating adaptor 8i and the load sensor 8p or between the load sensor 8p and the mounting feature 8m, may be used to axially position of the face of the melt sensor pin relative to the walls of the melt channels in the hot end.

While the designs hereto have been validated using physical artifacts produced by additive manufacturing with finish machining, it is understood that lower costs for higher quantities of hot ends may be produced by machining alone. The primary issue with machining is the formation of the wider and thinner section of the melt channel because of the thinness of this section requires a slender cutting tool. However, this constraint can be overcome various means. One approach is to use electrical discharge machining with an electrode to form cavity of the melt channel. Another approach is to split the hot end into two or more pieces whereby the interior cavity of the melt channel may be readily formed by machining. The machined hot end components may then be assembled, fastened, press fit, brazed, or welded to provide the hot end with the desired geometry.

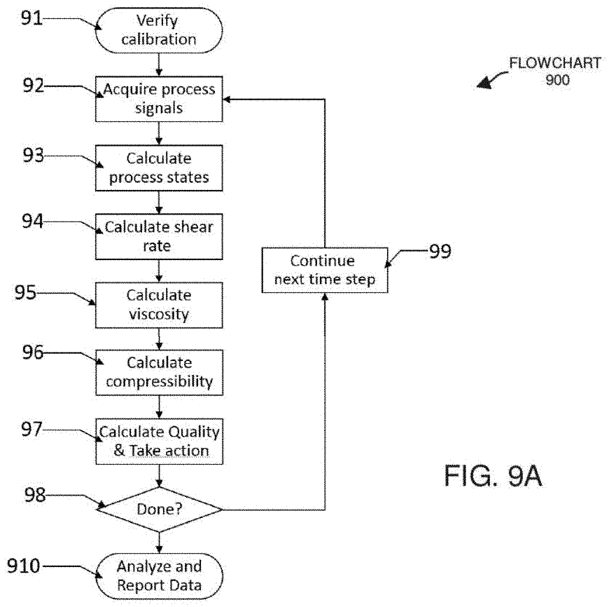

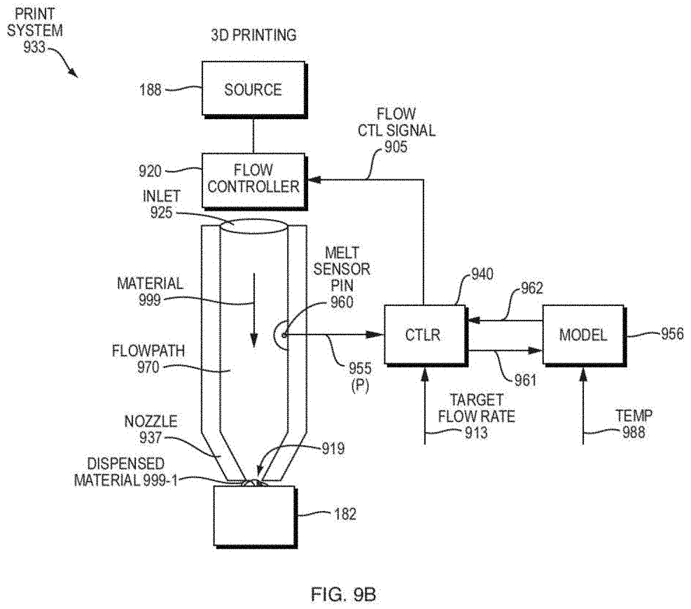

The embodiments herein with varying instrumentation may be used for general process monitoring and control according to the method operations described in flowchart 900 of FIG. 9. Calibration is typically first performed at step 91 by characterizing the acquired signals as a function of known applied process states. Linear or multiple regression models may be statistically fitted to derive a relationship between the process states and the output signals of the various sensing means.

For example, the output signal for load sensing element such as including the load cell 77, load beam 8p, and other types of load sensors may vary as a function of the ambient temperature or applied excitation voltage. As such, the output signal may be characterized as a function of the ambient temperature and applied excitation voltage to provide high fidelity sensing of the process states.

The process signals are periodically acquired at process step 92. A data acquisition module connected to a controller 940 may be used to acquire analog or digital voltages from the various sensing means, with or without intermediate signal conditioning devices. For example, a load cell or thermocouple may provide an analog voltage on the scale of 0 to 50 mV that is amplified by an amplifier (such as Sparkfun P/N SEN-13879) to a voltage that matches a desired range that is compatible with the data acquisition system. Alternatively, the data acquisition system may provide internal amplification or an adjustable input range to directly process signals of varying magnitude. Typical resolutions are 12 to 16 bits of precision, with greater precision generally being preferable. Alternatively, breakout boards with amplification, analog to digital conversion, and serial communication by Inter-Integrated Circuit (I2C) standards may be used such as the load cell signal conditioner (Sparkfun P/N SEN-15242) or thermocouple signal conditioner (Sparkfun P/N MCP9600). Sampling rates will vary widely by type of signal and objectives in application. In one embodiment, 100 Hz is suitable in most applications, though reliable sensing of noisy signals such as acceleration and temperature is often best achieve by sampling at much higher rates such as 100 kHz and then downsampling or digitally filtering the data. As later described, the data may be further analyzed to derive a compact set of rich data that efficiently represents the process.

In accordance with further example embodiments, the process states are then estimated at step 93 by using the acquired process signals and the calibration models. For example, the pressure 955 of the material 999 being processed may be estimated by the acquired load divided by the projected area of the melt sensor pin 960. As another example, the flow rate of the material 999 being processed can be estimated from the linear displacement of the filament as estimated from the extruder's motor stepping (such as material flow control 920 controlling a rate of the material 999 through the channel 970) or acquired from an optional filament position encoder.

In one embodiment, a filament position encoder includes use of a rotary magnetometer (such as a Melexis MLX90363) in conjunction with neodymium magnet with diametric magnetization (such as a KJ D42DIA-N52) to track the position of an idler gear mounted just above the extruders feed gears. Such a configuration with a 10 mm diameter idler gear and a 14 bit resolution on the analog to digital conversion of the rotation angle can provide approximately 2 micron accuracy on the filament position, from which the volumetric flow rate of the infeed may be readily calculated.

As another example of the process states calculated at step 93, the velocity of material 999 through the hot end (channel 970) may be estimated by integrating the acceleration signal from the position sensor with respect to time. To the extent that the accelerometer may provide a noisy signal, data may be acquired at a high sampling rate and a digital filter applied to provide improved estimates of the true acceleration of the hot end.

Results as later provided used a low pass filter having a 3 dB cut-off frequency of 23.9 Hz, corresponding to a Nyquist frequency of 34.4 Hz. The transient velocity of the material 999 is then estimated as the integral of acceleration, and calibrated relative to the known minimum and maximum velocities of the hot end as driven by the stepper motors.

As yet another example, the shear rate and viscosity of the material being processed can be estimated as subsequently described at steps 94 and 95. Then, the pressure drop in the melt channel may be calculated as the product of the flow resistance, viscosity, and melt flow rate. This pressure drop may then be subtracted by the melt pressure estimated with the load cell to estimate the pressure of the material being processed at it exits the orifice of the nozzle. Other process states may be likewise acquired from other sensors and appropriate calculations. Yet other process states can be estimated based on combinations of process signals.

At steps 94 and 95, embodiments herein include estimating the apparent shear rate at the wall (of channel 970) and the apparent viscosity of the material 999 being processed. Here, the word “apparent” is used according to its plain and ordinary meaning to mean a useful, representative value. The reason is that the shear rate and viscosity of the material (flowable material 199 of 999) being processed will vary in space down the length and across the thickness of the melt flow channel. As such, reasonable estimates of the apparent shear rate and apparent viscosity of the material can be acquired by modeling the melt channel as a series of rectangular or cylindrical flow channels.

Alternatively, useful estimates of the apparent shear rate and apparent viscosity can be acquired by modeling the flow and pressure drop based on the cylindrical bore at the nozzle orifice. The reason is that the bore at the nozzle orifice has the smallest diameter and so tends to generally determine the behavior of the material being processed. As such in the subsequent methods and results, in one embodiment, the apparent shear rate is simply calculated as 32 times the volumetric flow rate divided by the product of pi (3.14159) and the cube of the nozzle orifice 19 diameter. Likewise, the apparent viscosity is simply calculated as the product of the estimated pressure, pi, and the fourth power of the nozzle orifice diameter divided by the product of 128, the nozzle length, and the volumetric flow rate.

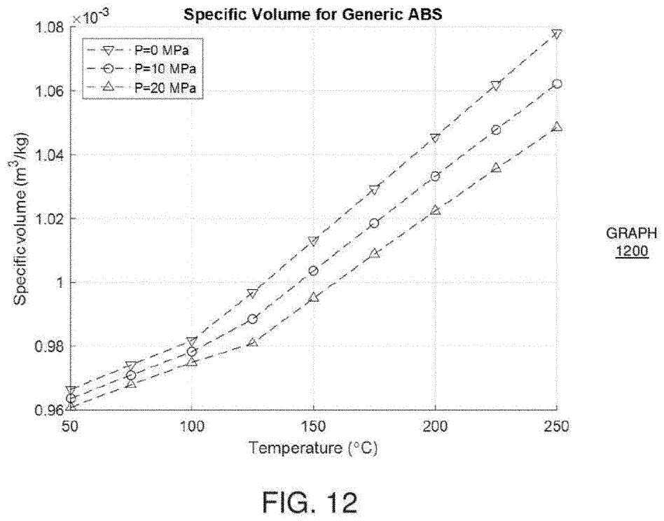

At step 96, the volumetric flow rate of the material 999 due to material compressibility (compression) is calculated as subsequently described with respect to FIG. 12 (illustrating a graph 1200) and the compressibility (compression) behavior of the material 999. A control action may be taken at step 97. Typical control actions include recording and/or analyzing the process states for further action, providing a corrective response based on the provided process and material states, aborting the printing process, and other operations. At step 98 of flowchart 900, a check is performed to verify if the process is completed or if the process should continue. If so, method steps 92-97 are repeated. Otherwise, the acquired data may be further analyzed and reported at step 910. For the subsequently presented results, the sampling rate was approximately 77 Hz, with a preferred range of sampling rates being 10 to 200 Hz.

FIG. 9B is an example diagram illustrating monitoring attributes of a material in a flow channel and adjusting flow control of material through the channel to dispense material at a desired target rate to fabricate a 3D printed object according to embodiments herein.

In this example embodiment, the print system 933 includes a source 188 (of 3D printing material 999), flow controller 920, flow path 970 (flow channel such as flow path 170 or modified version of same), controller 940, and model 956.

In general, the controller 940 controls a flow of the material 999 into the inlet of flow path 970 (flow channel). In general, it desirable to control a flow of the material 999 (i.e., eventually dispensed material 999-1) from the output 919 of the flow path 970.

If the material 999 is not compressible, then the rate of material through the flow path 970 is generally known based on a rate at which the flow controller 920 inputs flowable material 999 into the flow path 970. In other words, when material is not compressible, the rate of output of dispensed material 999-1 would be equal to the rate at which new material 999 is inputted to the flow path 970 at the inlet 925.

However, in one embodiment, the flowable material 999 is compressible. In such an instance, the dispensed material 999-1 flow rate from the outlet 919 is not necessarily the same as the flow rate of the material 999 inputted into the inlet 925. Embodiments herein include provide a desired output flow rate from the output 919 by taking into account a degree to which the material 999 in the flow path is compressed at any given time to adjust the input flow rate of material 999 from source 188 into the flow path 970 such that the rate of the flowable material 999-1 outputted from the outlet 919 is equal to or substantially equal to the target flow rate 913.

The adjustments based on compression of material as described herein provide greater control of the amount of flowable material 999-1 dispensed from the output 925, increasing an accuracy of fabricating the component 182.

In one embodiment, to control the flow rate of material 999 from the output 919 nearer a desired target flow rate 913, the controller 940 monitors one or more attributes (parameters) of the flowable material 999 in the flow path (flow channel) to determine a degree to which the known volume of material 999 in the flow path 970 is compressed. In one embodiment, this includes monitoring a pressure of the flowable material 999 in the flow path 970 (such as melt channel) via melt sensor pin 960 (i.e., a pressure sensor element). For example, the controller 940 receives signal 955 indicating a pressure of the material 999 in the flow path 970. As described herein, via model 956, the controller 940 determines a degree to which the material 999 in the flow path 970 is compressed.

In accordance with further example embodiments, to determine, a degree of compression, the controller 940 applies the received pressure value (via signal 955) to the model 956. Note that the input to the model 956 includes any suitable information to determine an amount of compression. For example, in one embodiment, the controller 940 also applies the temperature 988 (which is generally a fixed known temperature value indicating a temperature of the flowable material 999) of the material 999 in the flow path 970 to the model 956. If desired, instead of using an estimate of temperature, the controller 940 can be configured to monitor the temperature of the flow able material 999 in the flow path via a temperature sensor element in the flow path 970.

In accordance with further example embodiments, the controller 940 uses the estimated compression of material 999 in the flow path 970 and the input rate of material 999 into the inlet 925 of the flow path 970 to determine a rate of outputting the material 999-1 from the outlet 919. Based on these parameters, the flow controller 940 adjusts the rate of inputting material 999 into the inlet 925 into the flow path 970 to control a rate of the flow of material 999-1 to be the target flow rate 913 (which may vary over time). Such control ensures that a desired amount of material 999-1 is dispensed from the outlet 919 at any given time.

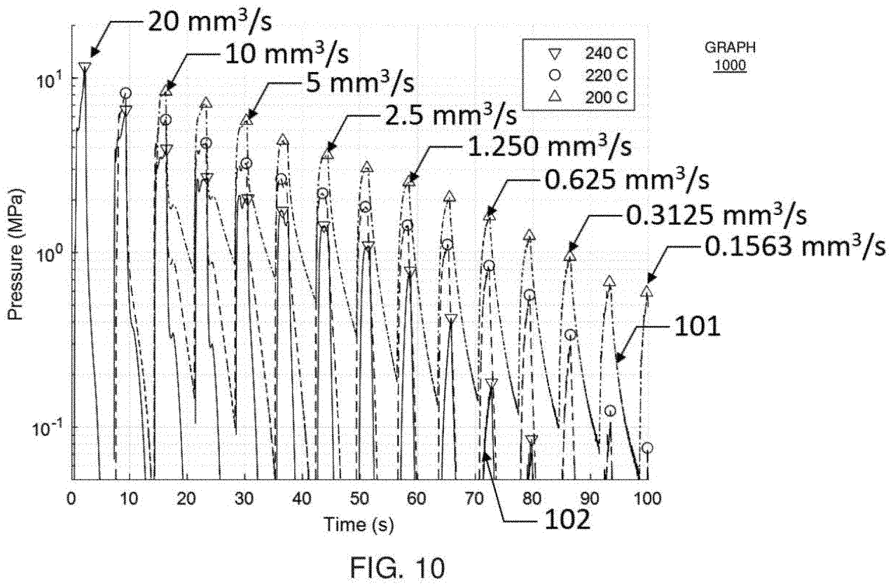

FIG. 10 (illustrating a graph 1000) provides transient pressure data acquired by an implementation of an embodiment described with respect to FIGS. 7 and 8 and the methodology described with respect to FIG. 9 (illustrating a method such as flowchart 900). To generate the data of FIG. 10, acrylonitrile butadiene styrene (Hatchbox ABS, red, 1.75 mm diameter) was processed at temperatures of 200, 220, and 240 C and volumetric flow rates of 20 to 0.1563 cubic millimeters per second in a geometric pattern with each flow rate decreasing by a factor of the square root of two. For each temperature and shear rate, the material was fed at the indicated flow rate for 3 seconds after which the inlet feed of the material was stopped. The highest flow rate for the material being processed at 220 degree C. (Celsius) and the two highest flow rates for the material being processed at 200 C were not performed in order to ensure that excessive pressures were not encountered, though this omission was later found unnecessary for this material.

The pressure data of FIG. 10 (illustrating a graph 1000) is important for at least three reasons. First, the results indicate that the material is certainly processable at volumetric flow rates of 20 cubic millimeters per second. By comparison, excess pressures and associated hesitation in the 3D printers were observed by the inventor at flow rates of 10 cubic millimeters per second when the same material was processed in a QIDI XPro with a stock hot end and the same nozzle tip as used in validation of this invention. Second, the transient pressure decay such as 101 indicates that the material is compressible such that subsequent leakage out of the nozzle is required to allow the internal pressure of the material being processed to equilibrate with atmospheric pressure. Third, just as there is a transient pressure decay after the inlet flow rate has been stopped, there is also a transient pressure rise upon suddenly increasing the flow rate from zero to the nominal flow rate at the inlet such as at 102. Accordingly, the pressure data of FIG. 10 not only serves to validate the melting capacity of the invention but also the importance of steps for compensating compressibility (compression) as subsequently described.

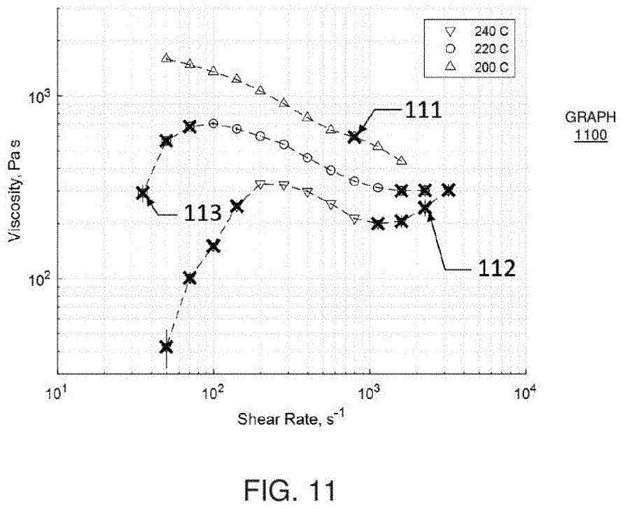

The methodology as described for FIG. 9 was applied to process data plotted in FIG. 10 to derive the apparent shear rate and apparent viscosity that are plotted in FIG. 11 (illustrating a graph 1100). Each of the symbols in FIG. 11 correspond to a symbol in FIG. 10 having a unique pressure, temperature, and flow rate. This viscosity characterization is readily implemented for any material provided to the hot end for processing, with a typical experiment requiring about 10 minutes across all the run conditions. This viscosity behavior is very useful since a viscosity model may be fit to the data, and then subsequently used to verify the suitability of prospective 3D printing programs (such as provided by g-code) and also improve the prospective 3D printing programs by compensating for compressibility (compression) or selecting optimal temperatures and flow rates for processing.

The results in FIGS. 10 and 11 were obtained in a fully automatic analysis of the data. In this analysis, the Matlab function peaks( ) was used with a minimum distance between peaks equal to one half of the planned time delay between the testing of the different flow rates (equal to 5 seconds in this characterization). The standard deviation of the data was then calculated from the sensed pressures for the 1 second of data adjacent the peak. The vertical error bars in FIG. 11 correspond to the peak pressures of FIG. 10 plus and minus one standard deviation of the pressures in the vicinity of the peak pressure. The coefficient of variation (COV) was then calculated as the standard deviation divided by the mean.

The shear rate and viscosity observations having a COV greater than 2% were identified in the data set. In FIG. 11, for example, the process behavior at point 111 exhibited too much random variation so the point was indicated as an outlier. Points on the extrema also tended to be outliers for different reasons. At high temperatures and flow rates such as at point 112, the melt viscosity behavior varied strongly during the flow rate characterization study and so these points were identified as outliers. It is understood that the steady state behavior would stabilize if extended characterization times were used, and it could be beneficial to include these data in a viscosity model whereby the viscosity was a function of not only the shear rate and temperature, but also the melting capacity of the nozzle and modeled temperature of the material being processed. At the opposite extreme, for low flow and shear rates, the pressures were so low so as to be almost unreadable. In this regime, pressures were on the order of 0.02 MPa (2.9 psi) or less. Given that the load cell (Aloce GB/T 7561-2009) had a load capacity of 10 kgf, the maximum melt pressure for the implemented design with a 3 mm diameter melt sensing pin was 45 MPa. Recalling the specifications for this load cell as previously described, the signal creep of 0.5% corresponds to a pressure of 0.23 MPa which explains the loss of signal at low shear rates and pressures. Accordingly, lower shear rates can be characterized by using load cells with a lower load capacity to provide greater low pressure sensitivity.

It should be mentioned that in this application, the fit between the melt sensor pin and the bore of the hot end was designed for a tight sliding fit. The bore of the hot end was 3D printed to have a nominal diameter of 2.9 mm, then drilled to a nominal diameter of 2.94 mm, then reamed to a finished diameter of 3.00 mm. Then, the diameter of the melt sensor pin was turned on a lathe to a nominal diameter of 2.98 mm. The melt sensor pin was able to be readily inserted into the bore of the hot end and freely rotated and slid by hand without undue force. With a clean melt sensor pin and bore of the hot end, the pin would almost not fall out of the assembly if the assembly was oriented with the melt sensor pin below the hot end. In operation, no leakage of the material being processed was observed after several hours of characterization and printing at varying processing conditions. One reason may be that the nominal clearance of 0.02 mm between the melt sensor pin and bore of the hot end was appropriate in this application. Another reason is that the side wall of the hot end receiving the melt sensor pin was provided an annulus 8a that tends to provide a dynamic seal by helping to center the melt sensor pin and also provide lower shear rates and higher viscosities in the vicinity of the annulus.

It is beneficial for computational purposes to fit the shear rate and viscosity data to a material constitutive viscosity model for the melt viscosity. Preferred material constitutive viscosity models include a Newtonian model, power-law model, Cross model, Carreau model, and others with temperature dependence modeled according to Arrhenius and WLF forms. It is possible to provide multiple corrections such as described by “Coogan, T. J. and Kazmer, D. O., 2019. In-line rheological monitoring of fused deposition modeling. Journal of Rheology, 63(1), pp. 141-155.” However, uncorrected rheological models are surprisingly useful in that they can include complex effects such as juncture losses and geometric modeling errors when characterization experiments are conducted on printers similar to those for which the models will be used. Alternatively, model coefficients for various materials are widely available as they are used in other polymer processing methods like injection molding and extrusion.

The volumetric flow of the extruded plastic is governed by the thermal expansion and compressibility (compression) of the polymer melt, both of which can be well modeled according to a compressibility (compression) model using the double domain Tait equation. The term “double domain” implies that the specific volume is modeled separately in the solid and melt states as a function of pressure and temperature, with constitutive equations and various model coefficients described by the inventor in the chapter “Shrinkage and Warpage” of his book “Injection mold design engineering, 2nd edition” published by Carl Hanser Verlag GmbH Co KG in 2016. The modeled specific volume for a generic ABS is plotted in FIG. 12; model coefficients are readily for other feedstock materials. While the double domain Tait equation is a preferred compressibility (compression) model, it is also possible to model the isothermal compressibility (compression) at varying temperature settings, then fit coefficients for a compressibility (compression) model in which the isothermal compressibility (compression) is modeled as a function of temperature.

It is also possible to characterize the compressibility (compression) of the material by replacing the nozzle of FIGS. 3-8 with a solid plug such as an M6 screw in the implemented embodiments. The filament may be fed into the sealed hot end in a controlled manner to characterize the pressure as a function of the volumetric compression. The test may be repeated at varying material temperatures to produce useful data from which the compressibility (compression) behavior may be estimated. For example, testing has been performed for the ABS material in which the material in the 3D printing apparatus was compressed by 2%, then decompressed, and then compressed by 4%. The test methodology was repeated for temperatures of 180, 200, 220, and 240 C, and the corresponding pressure increase was found to be 0.972, 0.891, 0.809, and 0.728 MPa when increasing the compression from 2 to 4%. The resulting isothermal compressibility (compression) (calculated at 2% divided by the pressure increase) was 2.06E-8, 2.25E-8, 2.47E-8, and 2.75E-8 square meters per Newton for material temperatures of 180, 200, 220, and 240 C. By comparison, the isothermal compressibility (compression) data plotted in FIG. 12 as calculated for a generic ABS material model with the double domain Tait equation estimated the isothermal compressibility (compression) as 1.28E-8, 1.41E-8, 1.55E-8, and 1.72E-8 square meters per Newton for material temperatures of 180, 200, 220, and 240 C.

These results show that characterizing the compressibility (compression) behavior with the instrumented apparatus provides a fairly good estimate of the pressure, volume, temperature (PVT) behavior as expressed by the double domain Tait equation using traditional characterization approaches as described by “Walsh, David, and Paul Zoller. Standard pressure volume temperature data for polymers. CRC press, 1995.” In the invented characterization methodology, it is understood that the modeled compressibility (compression) behavior is not the true compressibility (compression) behavior of the material at a single temperature, but rather a model of the compressibility (compression) behavior of the implemented system including the mechanical compliance of the material throughout the system at varying temperatures ranging from ambient temperature at the extruder to the controlled temperature of the hot end. For example, the methodology in the preceding data suggest that the observed compressibility (compression) in the real system is somewhat more than that described by the double domain Tait equation for the generic ABS. Even so, the resulting data is useful since it represents the true behavior of the implemented system and so is appropriate for modeling purposes as subsequently described.

Accordingly, the instrumented apparatus can be used in a characterization methodology in which the inlet flow rates or varying velocity profiles of a material to a 3D printing apparatus are varied in a controlled manner to observe the transient pressure across a wide range of inlet flow rates for a material being processed. The material constitutive models, such as the Cross-WLF model for the viscosity and the double domain Tait equation for the compressibility (compression), can then be used to estimate the transient pressure as a function of the varied inlet flow rates using models. The prediction errors, defined as the differences between the observed and estimated pressures, can then be used to adjust or fit model coefficients for the viscosity and compressibility (compression) behavior of the material so that the observed and estimated behaviors better coincide. These fitted material constitutive viscosity and compressibility (compression) models can then be used for purposes of modeling and control of 3D printing processes as described according to subsequently described embodiments. The printed road width may be readily estimated as the estimated outlet flow rate divided by the product of the print velocity and layer height. Alternatively, measuring the part dimensions such as the road width for a part printed with a varying velocity profiles provides an excellent way to check validity of the models and vary the viscosity model, compressibility (compression) model, or printer geometry model accordingly.

Several embodiments of inventive methods for modeling and control of 3D printing are next described. The first embodiment was applied to a Lulzbot Taz6 printer with a stock hot end and nozzle having an orifice of 0.4 mm. To investigate the role of transient melt pressures on compressibility (compression), a full factorial design of experiments (DOE) was implemented with three factors at three levels. The three factors (and levels) were: (1) layer height, H (0.10, 0.25, and 0.40 mm); (2) road width, W (0.35, 0.50, and 0.65 mm); and (3) print speed, S (1000, 2500, and 4000 mm/minute). The DOE was a full factorial design with three factors at three levels; only 23 runs were performed as runs with a volumetric flow rate above ten cubic millimeters per second were omitted to avoid drops in melt temperature and excessive melt pressures.

The bed and nozzle temperature were set to their central values for processing HIPS recommended by the material supplier (eSun (Shenzhen, China)), equal to 80 and 250° C., respectively. The implemented DOE is provided in TABLE 1. The invented methods are provided with respect to DOE run 15, marked with an asterisk, with summary results provided for all runs.

TABLE 1
Design of experiments and width standard deviations

| | | | Widths (mm) | | |
|---|---|---|---|---|---|
| DOE Run | H (mm) | S (mm/s) | W (mm) | Std Dev | SD Corr |
| 21 | 0.4 | 66.67 | 0.35 | 0.195 | 0.049 |
| *15 | 0.25 | 66.67 | 0.5 | 0.298 | 0.062 |
| 12 | 0.25 | 66.67 | 0.35 | 0.248 | 0.048 |
| 9 | 0.1 | 66.67 | 0.65 | 0.544 | 0.095 |
| 6 | 0.1 | 66.67 | 0.5 | 0.477 | 0.077 |
| 3 | 0.1 | 66.67 | 0.35 | 0.390 | 0.114 |
| 23 | 0.4 | 41.67 | 0.5 | 0.144 | 0.026 |
| 20 | 0.4 | 41.67 | 0.35 | 0.123 | 0.036 |
| 17 | 0.25 | 41.67 | 0.65 | 0.210 | 0.038 |
| 14 | 0.25 | 41.67 | 0.5 | 0.186 | 0.030 |
| 11 | 0.25 | 41.67 | 0.35 | 0.156 | 0.024 |
| 8 | 0.1 | 41.67 | 0.65 | 0.339 | 0.048 |
| 5 | 0.1 | 41.67 | 0.5 | 0.297 | 0.040 |
| 2 | 0.1 | 41.67 | 0.35 | 0.242 | 0.054 |
| 25 | 0.4 | 16.67 | 0.65 | 0.061 | 0.015 |
| 22 | 0.4 | 16.67 | 0.5 | 0.054 | 0.014 |
| 19 | 0.4 | 16.67 | 0.35 | 0.045 | 0.010 |
| 16 | 0.25 | 16.67 | 0.65 | 0.078 | 0.019 |
| 13 | 0.25 | 16.67 | 0.5 | 0.069 | 0.017 |
| 10 | 0.25 | 16.67 | 0.35 | 0.058 | 0.014 |
| 7 | 0.1 | 16.67 | 0.65 | 0.124 | 0.029 |
| 4 | 0.1 | 16.67 | 0.5 | 0.108 | 0.027 |
| 1 | 0.1 | 16.67 | 0.35 | 0.088 | 0.088 |
| | | | Mean | 0.197 | 0.042 |

For each run of the DOE, a base layer 0.75 mm wide and 0.30 mm high was printed to minimize inaccuracies caused by the leveling process. A second layer was then printed at the conditions indicated in TABLE 1. An “out & back” print was provided consisting of: (1) a 5 s steady line at run conditions per TABLE 1; (2) a 2 mm deceleration to a print speed of 5 mm/s while maintaining the same layer height & road width; (3) a 1.06 mm transverse line at a print speed of 5 mm/s while maintaining the same layer height & road width; (4) a 2 mm acceleration to the set print speed while maintaining the same layer height & road width; and (5) a 5 s steady line at run conditions per TABLE 1.

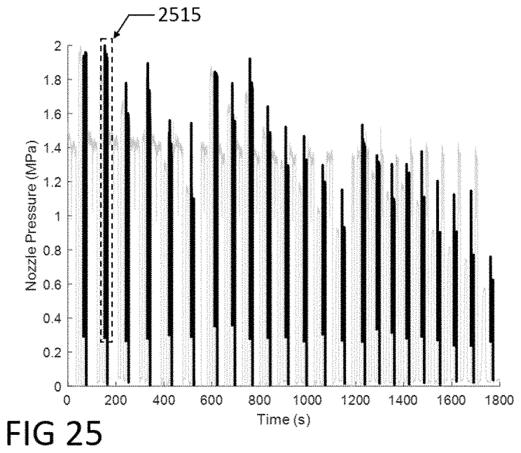

The nozzle pressure was acquired across the DOE runs listed in TABLE 1. The data were acquired at a sampling rate of 250 kHz, then down sampled to a rate of 100 Hz for analysis and storage. FIG. 25 plots the transient nozzle pressure data across the 1800 s duration of the implemented DOE. It is observed that the nozzle pressure varies not only with the DOE run settings of TABLE 1, but also with the printing of the base layer and nozzle repositioning between DOE runs. The bold portions of the trace correspond to the printing of the top sample layer of interest while the lighter portions of the trace correspond to the printing of the base layer. Box 2515 indicates the portion of interest with respect to DOE run 15 as subsequently detailed with respect to the inventive methods.

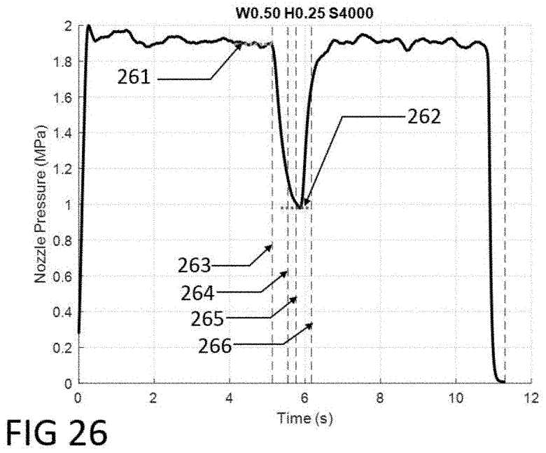

FIG. 26 plots the transient melt pressure for DOE run 15 in which the print speed is 4000 mm per minute, the desired road width W if 0.5 mm, and the road height H is 0.25 mm. It is observed that the nozzle pressure varies from around 1.9 MPa at a print speed of 4000 mm per minute (corresponding to location 261) to less than 1 MPa at a print speed of 10 mm per second (corresponding to location 262). The vertical lines represent the transition in velocities: time 263 is the start of the linear ramp from 4000 mm per minute to 600 mm per second at time 264 while time 265 is the start of the linear ramp from 600 mm per minute to 4000 mm per second at time 266. The curvature and lag in the transient melt pressure is due to the compressibility (compression) of the material being processed.

The compressibility (compression) can be well estimated based on the specific volume v modeled with double domain Tait equation given the temperature of the material being processed in the adaptor and hot end as well as the acquired time varying pressure, P(t). Using a backward difference for a time step Dt, the volumetric flow QC due to compressibility (compression) is estimated as:

$$Q C = {\sum }_{i ∈ [ Adaptor , Hot End ]} \frac{{V}_{i} ( S V ( {T}_{i} , P ( t ) ) - S V ( {T}_{i} , P ( t - D t ) ) )}{S V ( {T}_{i} , P ( t ) ) D t}$$

where V is the volume and SV is the specific volume in the extruder adaptor and hot end sections as a function of pressure and temperature. For the design of experiments and analysis, the temperature of the material in the adaptor and hot end sections are estimated as 50° C. and 250° C., respectively.

Given the output volumetric flow rate due to the driven extrudate flow rate QE and the compressible volumetric flow rate QC, the road width, w, can be estimated as from the layer height, H, and print speed, S, as:

w=(QE+QC)/(HS)

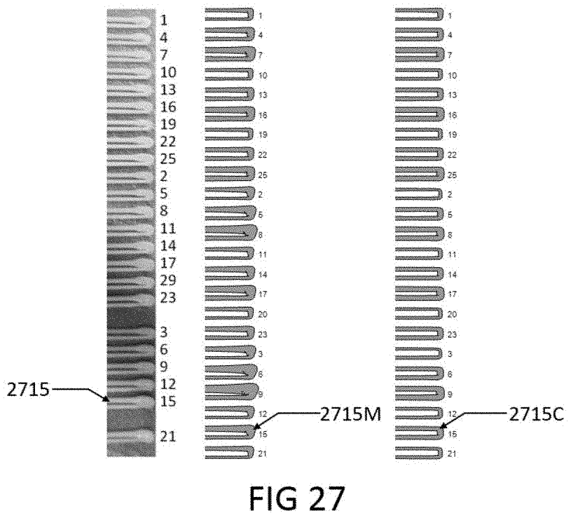

The magnitude of the compressible volumetric flow rate QC can be on the order of, or even greater than, the driven extrudate flow rate QE given the rapid changes in melt pressure in combination with larger volume of material being processed between the nozzle orifice and the extruder. The actual road were produced according to the described design of experiments and photographed. FIG. 27 provides an image of the printed cross section with print 2715 representing the observed print corresponding to the acquired nozzle pressure plotted in FIG. 26. It is observed that there is extensive variation in the printed road widths for this and the other printed roads corresponding to the various DOE run conditions. The road width and other part dimensions may be physically measured using a caliper or micrometer, optically measured using an optical comparator or photographic measurements, or otherwise measured for example using a thickness gage based on the Hall effect.

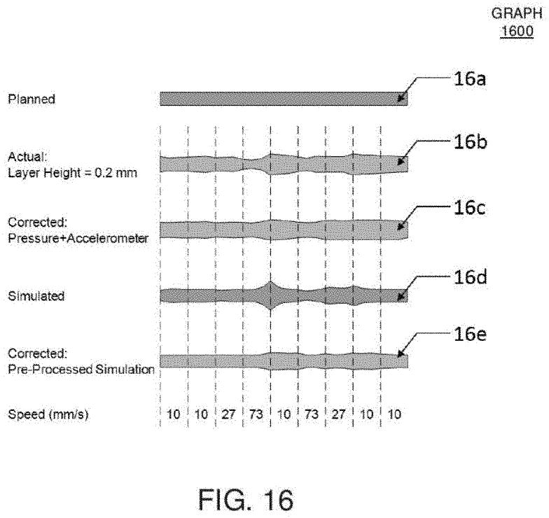

The printed road widths may be estimated in real-time during the printing process as the melt pressures are observed. Alternatively, the printed road widths may be estimated after the printing process based on the acquired melt pressures. The modeled road widths estimated based on the acquired melt pressures of FIG. 25 are plotted in FIG. 27, wherein plot 2715M corresponds to the melt pressures plotted in FIG. 16 for the printing of print 15150. Generally, the shape and road widths in the modeled prints closely follow the shape and road widths of the observed prints.

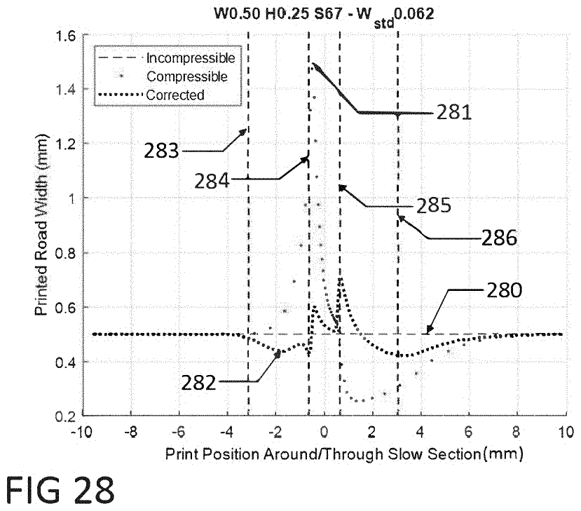

FIG. 28 provides the control actions for the modeled road width 1515M as a function of the print position adjacent and through the slow section. The horizontal axis of FIG. 28 corresponds to the print length in millimeters wherein the 0 position corresponds to the center of the slow section printed at a velocity of 600 per minute. The vertical lines represent the transition in velocities: position 283 corresponds to time 263 for the start of the linear ramp from 4000 mm per minute to 600 mm per second at position 284 and time 264 while position 285 and time 265 is the start of the linear ramp from 600 mm per minute to 4000 mm per second at position 286 and time 266. The dots 281 represent the estimated road width for the compressible material relative to the expected road width 280 being a constant 0.50 mm that is traditionally programmed assuming an incompressible material. The curvature and lag in the transient road width are due to the compressibility (compression) of the material being processed.

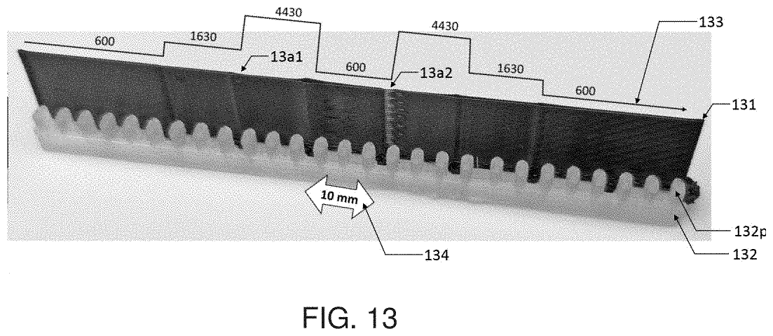

The fact that the modeled road widths are well modeled indicates that compensating for the compressibility (compression) behavior of the material is useful for control. Further inventive details are presented with a validation part shown in FIG. 13 which comprises a single-walled part 131 having a planned road width of 0.5 mm, a length of 90 mm, a height of 10 mm, and layer heights of 0.2 mm. The validation part is shown in a validation fixture 132 that locates the part 131 and provides regular measurement locations between protrusion 132p for characterizing the width of the part. To characterize the dynamic behavior of the printing process, a velocity profile 133 is specified as a function of the length location. This velocity profile is derived from a full factorial design of experiments (DOE) for two factors (starting and ending velocity) and three levels (0, 1, and 2). The nine combinations would be 0x0, 0x1, 0x2, 1x0, 1x1, 1x2, 2x0, 2x1, and 2x2. Since holding the velocity at the same velocity isn't of much interest, those DOE runs are omitted. The remaining six runs are rearranged as 0x1, 1x2, 2x0, 0x2, 2x1, and 1x0. This run arrangement results in the indicated velocity profile of FIG. 13 where the velocity is equal to 600 mm/s times exp(n) where n indicates the aforementioned level of the velocity (0, 1, and 2). This validation part was processed using the same ABS (Hatchbox ABS, red, 1.75 mm diameter) as previously described with a hot end temperature of 230 C and a bed temperature of 100 C. While FIG. 13 is directed to modeling and controlling compressibility (compression) as a function of print velocity, a design of experiments can be performed to model and control the compressibility (compression) behavior as a function of other printing parameters of interest such as layer height, hot end temperature, and others. The methods described herein for modeling and control directly apply to varying printing conditions.

Visual inspection of the part 131 in FIG. 13 shows that the part width varies substantially with the length location and velocity of the printing. The reason is that changes in velocity are accompanied with proportional changes in the extrudate flow rate in order to yield the desired road width. However, as the pressure data of FIG. 10 has already suggested, the material being processed may be relatively compressible. As such, increasing the velocity results in an increase in pressure, compressibility (compression) of the material, and a delay in the flow rate delivered out of the nozzle orifice. The result is a substantially thinner printed part at locations 13a1 and 13a2. Likewise, decreasing the velocity results in excess flow out of the nozzle and thicker part such as in the intermediate locations between 13a1 and 13a2. These effects are analogous to the variations in the printed road widths observed in FIG. 27 due to the varying pressures in FIG. 25. It is therefore an object of the invention to provide methods for predicting and correcting these effects in general 3D printing applications.

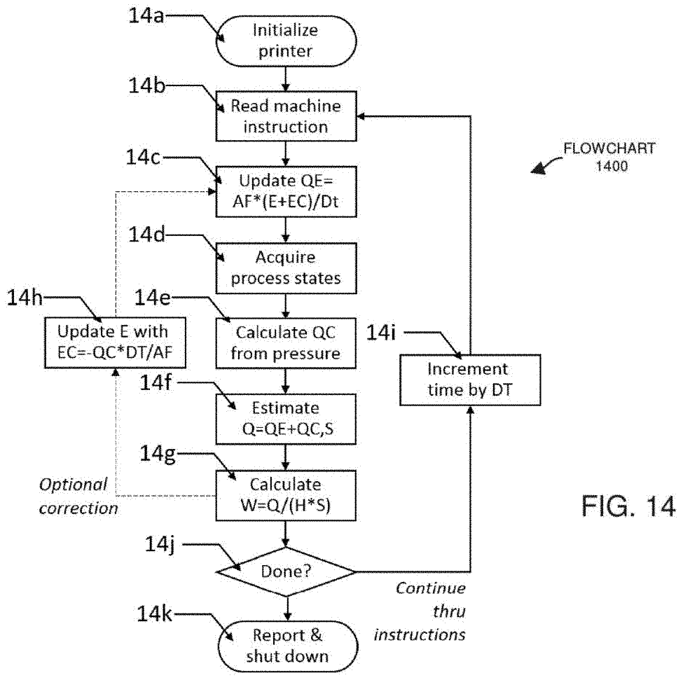

FIG. 14 (illustrating a method such as flowchart 1400) provides a method for controlling the 3D printing process to adjust the extrusion speed based on process data from the apparatus. In this example, the methods include use of the acquired melt pressure and velocity for the embodiments of FIGS. 7 and 8 based on feedback signals from the implemented load cell and accelerometer. While both melt pressure and velocity are used in this example, validation has separately performed using feedback with just pressure, and again separately performed using feedback with just acceleration. The provided methods are provided for illustrative purposes and neither intended to require the use of both pressure and acceleration nor intended to prohibit the use of other feedback signals.

Per the method of FIG. 14, the printer is initialized at step 14a. This step includes setting the temperatures and fans, loading and purging filament, loading part property specifications, loading material model coefficients, loading data acquisition parameters such as sampling rates and gains and filter values, performing calibration, and other typical steps associated with starting a print. The machine instructions are read (obtained from storage hardware) at step 14b. If the instruction does not involve movement, then the instruction is executed. Changes in temperature or feed rates are recorded in machine memory for subsequent computations. If the step involves movement, then the flow rate from the extruder (represented by the variable QE) is calculated at step 14c as the sum of the extrudate length (represented by the value E) and extrudate correction (represented by value EC, initially set to 0 but subsequently calculated as later described) multiplied by the cross-section area of the filament (represented by value AF) divided by the time step value (Dt) such as change in time.

The process states are then calculated at step 14d as previously described with respect to FIG. 9. The flow rate due to changes in compressibility (compression) (i.e., amount of compression as represented by QC) is then estimated at step 14e. The preferred method as implemented discretizes the melt channel into a series of segments of varying length, thickness, and width for generally rectangular sections or segments of varying length and diameter for generally cylindrical segments. The temperature and pressure in each segment of the flow channel is estimated either by simulation or linear interpolation (such as implemented by controller 140 or other suitable entity) based upon the acquired process states (such as based on feedback 186 from one or more sensors 189 or otherwise estimated states of the parameters without receiving feedback 186). The specified volume (represented by SV) is then calculated based on the double domain Tait equation or a look-up table of SV based on experimental characterization as previously described with respect to FIG. 12. The flow rate due to changes in compressibility (compression), QC, is then calculated as QC=V*(SV(t−Dt)/SV(t)−1)/Dt wherein V represents the volume of each flow segment, t represents the current time, and Dt represents the time step. While other estimation methods for the compressible flow can be used, this particular implementation has provided suitably accurate and easy to compute.

The total flow rate (represented by Q) is then calculated as the sum of QE and QC at step 14f. The linear velocity of the hot end (represented by S) is then calculated based on the X, Y, and Z velocities of the hot end relative to the bed. As previously described, in this example the velocity is integrated from accelerometer data but the X, Y, and Z velocities from the instructions to the stepper motors or other actuators may also be used. The resulting width of the extrudate (represented by W) is then calculated at step 14g as the total flow rate divided by the linear velocity, S, and the layer height (represented by H).

The dashed lines in FIG. 14 adjacent step 14h indicate an optional corrective action to update the filament position based on the compressible flow rate, QC. The extrudate correction, EC, is equal to the opposite of the product of QC and Dt divided by AF as these terms have been previously defined. While corrective actions are typically desired, the method of FIG. 14 is still useful even without corrective action to predict the width based on the acquired process states and estimated compressible flow. While the method of FIG. 14 has focused on width, it is understood that other part properties such as filled volume, void fraction, part dimensions, and layer strength may also be readily modeled and controlled.

After each instruction, a check is performed at step 14j to see if the set of the instructions is complete. If not, the time is updated by the time step Dt and the operation continues with the next machine instruction at step 14b. While one primary outer loop for reading the machine instructions in indicated in FIG. 14, it should be understood that it is preferable to update the process states and machine control by performing steps 14c to 14h at a higher frequency. For example, a machine instruction may specify the printing of a road segment having a length of 40 mm at a print speed of 20 mm/s. The time required to estimate the instruction would then be 2 s. However, the dynamics of the printing process may vary substantially within this time span, especially if the process was not steady state at the beginning of the segment. As such, the time step Dt actually refers to the time step for updating the process states and control actions. In the actual implementation, the inventor has found that updating the process states at a sample rate around 100 Hz is preferable for having accurate process information. At the same time, the inventor has found that updating the control actions at a rate of 10 Hz is preferable to avoid excessive control commands. These frequencies are provided for illustrative purposes and may vary with the machine design and application requirements. Regardless, the control engineer would understand that the iteration described in FIG. 14 may provide multiple nested loops of varying times for different purposes.

Data may be provided, analyzed or stored for each machine instruction as well as process steps therein, typically at step 14j. The analysis may include statistical analysis such as described by the inventor in the article Kazmer, D. O., S. Westerdale, and D. Hazen. “A comparison of statistical process control (SPC) and on-line multivariate analyses (MVA) for injection molding.” International Polymer Processing 23, no. 5 (2008): 447-458. Alternatively, the analysis may include a finite element simulation of the completed process including flow, heat transfer, and stress relaxation such as described by the inventor in the article Fan, Bingfeng, David O. Kazmer, Wit C. Bushko, Richard P. Theriault, and Andrew J. Poslinski. “Birefringence prediction of optical media.” Polymer Engineering & Science 44, no. 4 (2004): 814-824 as well as the article Fan, Bingfeng, David O. Kazmer, Wit C. Bushko, Richard P. Theriault, and Andrew J. Poslinski. “Warpage prediction of optical media.” Journal of Polymer Science Part B: Polymer Physics 41, no. 9 (2003): 859-872. While these latter references were developed for injection molding, the underlying concepts are applicable to the described injection printing process.

After completion of the printing process, a final report may be provided at step 14k. The report may include the estimates of the part properties, process states, material properties, energy usage, and other outputs including statistics thereof. Based on these statistics and the part property specifications, a determination may be made as to the suitability of the printed part. For example, the part may be deemed satisfactory or unsatisfactory or provisionally satisfactory given subsequent inspection and rework. Alternatively, the estimated part properties may be graded against the part property specifications. A colored contour map showing the locations of potential issues may be provided wither in graphical form or as a matrix of numerical values. These outputs may be provided to either a human end-user or downstream machinery for further actions such as packaging, post-processing, rework, recycling, or disposal.

FIG. 14 provides a method for real-time control based on sensing of melt pressures during 3D printing. It turns out that a variant of FIG. 14 has been validated and found highly useful without using sensed melt pressures at all. In this second variation of FIG. 14, the melt pressure at each time step is simulated or estimated by a model of a planned printing process as opposed to being acquired from a sensor in an operating printing process as indicated at block 14d. This is accomplished by modeling the pressure drop given the known flow channel geometry, flow rate of the extrudate, melt temperature, and material constitutive model for the melt viscosity. The models can be quite simple, even based on isothermal flow in a tubular or strip section according to Hagen-Poiseuille and Hele-Shah flow equations. For example, given a flow rate, Q, of a material with an apparent constant (Newtonian) viscosity, eta, through a cylindrical channel of length, L, and diameter, D, the pressure, P, may be estimated as 128*eta*L*Q/(pi*D\hat{ }4).

While the equation in the previous paragraph was for a material represented with a constant viscosity, the pressure can model the viscosity as a function of temperature, shear rate, and pressure according to a variety of material constitutive models as described elsewhere herein. The simulation can also discretize the geometry of the flow channel in the 3D printing apparatus into a number of flow segments along the length of the flow channel as well as a number of layers through the thickness of the flow channel so as to accurate compute the flow conductance and melt pressure distribution from the inlet to the outlet. Examples for simulating the melt pressure include the inventor's Masters' Thesis “A Radial Flow Analysis Tool” to Rensselaer Polytechnic Institute (1991), Chapter 6 titled “Feed System Design” in his book Injection Mold Design Engineering (2016), and “Fan, B., Kazmer, D. O., Theriault, R. P. and Poslinski, A. J., 2003. Simulation of injection-compression molding for optical material. Polymer Engineering & Science, 43(3), pp. 596-606.” By comparison with these molding simulations, the simulation of the 3D printing process simulates the extrusion of the material through the 3D printing apparatus as the machine instructions vary the apparatus' positions, temperatures, velocities, and flow rates as a function of time.

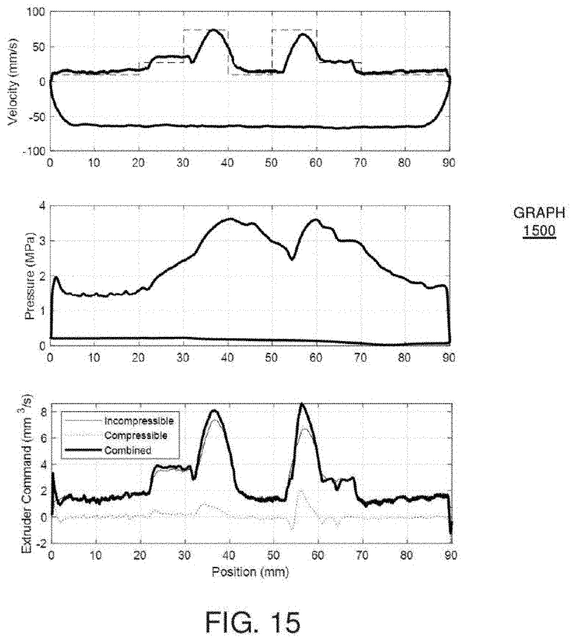

The implementation of the methods of FIG. 14 to the application of FIG. 13 results in the signals and corrective actions provided in FIG. 15. The dashed trace in the top subplot provides the specified velocities described with respect to FIG. 13 as a function of the length position. The bold lines in the top subplot provide the estimated velocity of the hot end from the accelerometer data using the methods as previously described. It is observed that the velocities are slightly above the lowest specified speeds while there is lag in the velocity at the highest specified speeds. The pressure of the material being processed in the hot end are provided in the middle subplot. It is observed that the pressures tend to follow the print velocity since the flow rate of the material being processed is generally proportional to the print velocity.

The bottom subplot of FIG. 15 (illustrating a graph 1500) provides the extruder command per the methodology described with respect to FIG. 14. Specifically, the incompressible flow rate QE is calculated per method step 14c while compressible flow rate is provided by method step 14e. The corrected extrudate flow rate per method step 14h and 14c is then fed back to the extruder. There are several methods by which the corrective action may be implemented. A first method is to iterate on printed parts wherein the process data for the previous printed part informs the control of the subsequent printed part; the advantage of this method is that a stock printer with a stock controller may be used with the described hot end. A second method is to perform the corrective actions in real time or near real time, meaning as the process data is being acquired such as at a frequency of 10 to 100 Hz. In this implementation, the first method has been used. However, the inventor has performed both types of methods in other polymer processing operations such as Dynamic Feed for injection molding and found the results of the different methods to be very similar. Accordingly, either method may be implemented depending on the control system design and application requirements.

FIG. 16 (illustrating a graph 1600) plots the measured width of the printed parts. The desired result as indicated at 16a is a part with a constant wall thickness of 0.5 mm. The actual part as shown at 16b has substantial variation that also corresponds to the image of the part 131 shown in FIG. 13. With the control of FIGS. 14 and 15, the width profile shown at 16c is obtained. Inspection of 16c relative to 16b reveals that the part width has less variation with the feedback control than the part with conventional printing. The statistics are provided in TABLE 2. Inspection of the results shows that the pressure and acceleration control provides a lower standard deviation than the conventional printing but a higher mean width. The reason for the higher width with control is that the velocity from the accelerometer is over estimated across a large portion of the printed length. As such, the provided extruded flow rate was higher than required in the actual process. This result could be readily corrected by further calibration of the velocity model. Even still, the results are provided as an example of reducing the variation in part width by compensating for the effects of compressible flow.

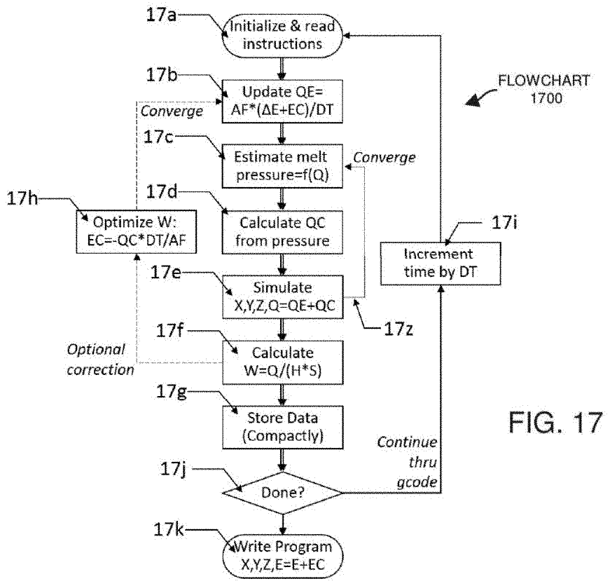

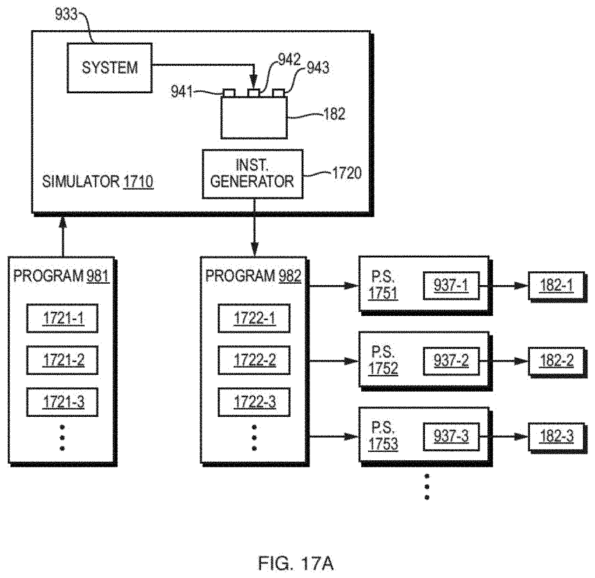

TABLE 2
Width statistics of validation part shown in FIG. 13

| | Mean | Standard |
|---|---|---|
| | Width | Deviation |
| Method | (mm) | (mm) |
| Desired (FIG. 16a) | 0.5 | 0.000 |
| Actual, uncorrected (FIG. 16b and | 0.587 | 0.120 |
| FIG. 13) | | |
| Control (pressure & acceleration, | 0.656 | 0.084 |
| FIG. 16c per FIG. 14) | | |
| Simulated (no control, FIG. 16d per | 0.531 | 0.197 |
| FIG. 17 without 17h) | | |
| Control (simulation, FIG. 16e per | 0.527 | 0.068 |
| FIG. 17 with 17h) | | |

FIG. 14 provides a method for real-time control based on sensing of melt pressures during 3D printing. It turns out that a variant of FIG. 14 has been validated and found highly useful without using sensed melt pressures at all. In this second variation of FIG. 14, the melt pressure at each time step is estimated by a model rather than acquired from a sensor as indicated at block 14d. This is accomplished by modeling the pressure drop given the known flow channel geometry, flow rate of the extrudate, melt temperature, and material constitutive model for the melt viscosity. The models can be quite simple, even based on isothermal flow in a tubular or strip section according to Hagen-Poiseuille and Hele-Shah flow equations. Examples include the inventor's Masters' Thesis “A Radial Flow Analysis Tool” to Rensselaer Polytechnic Institute (1991), Chapter 6 titled “Feed System Design” in his book Injection Mold Design Engineering (2016), and “Fan, B., Kazmer, D. O., Theriault, R. P. and Poslinski, A. J., 2003. Simulation of injection-compression molding for optical material. Polymer Engineering & Science, 43(3), pp. 596-606.” However, there are some significant differences between the developed simulation as described herein for 3D printing and the prior injection molding simulations. A first significant difference is that injection molding as described herein is performed in a closed mold cavity subject to flow boundaries defined by the mold cavity walls. By comparison, 3D printing tends to extrude the material into the ambient environment with an atmospheric boundary condition at the edge of the extruded roads. A second significant difference is that injection molding is performed with a stationary injection point and relatively simple profiling of the inlet flow rate and pressure boundary conditions. By comparison, 3D printing generally requires the execution of lengthy sets of instructions with varying positions, velocities, and flow rates.

The correction method based on melt pressure estimation relies on a material constitutive model for the melt viscosity. Preferred material constitutive models include a Newtonian model, power-law model, Cross model, Carreau model, and others with temperature dependence modeled according to Arrhenius and WLF forms. The coefficients for these are widely available as they are used in other polymer processing methods like injection molding and extrusion. Alternatively, the model coefficients can be readily estimated by operating a rheometer or a printing process with a melt pressure sensor at varying flow rates such as previously described with respect to FIG. 11.

In one embodiment, the operations of the flowchart 1700 (FIG. 17) below are applied to system as shown in FIG. 17A without physical monitoring of the one or more parameters such as temperature, pressure, etc.

In general, FIG. 17A illustrates implementation of the system in FIG. 9B using a simulation to provide correction/modification to one or more fabrication instructions that can be used in other nozzles of a similar type to create a more accurate renditions of component 182.

For example, the implementation of FIG. 17A includes a full or partial simulation of printing a component 182 using controller 940 with a particular type of nozzle 937 (having known characteristics such as having same flow path 970 dimensions, etc.) and a particular type of material 999. The simulator 1710 determines, from the simulation, a respective compression of the material 999 during the simulated fabrication of the component 182 using a first set of fabrication rules (such as based on one or more rules defining the printing process: i) a particular type of print material 999 to be used in printing, ii) corresponding model 956 indicating compression of the print material 999 at different pressures, temperatures, etc., iii) movement of nozzle 937, iv) rate of inputting material 999 into inlet 925 of the flow path 970 as the corresponding nozzle 937 is moved while dispensing material 999-1 and create the component 182, v) expected output amount and/or flow rate of material 999 as the nozzle is virtually moved to create a virtual rendition of the component 182, etc.).

The first set of fabrication rules is known as machine setup and or machine instructions below.

Note that execution of one or more of the fabrication instructions in program 981 to fabricate a respective component 182 may result in an undesired virtual fabrication of a road (layer of material) on the virtually fabricated component 182. In other words, execution of a respective instruction may intend to produce a road of particular one or more dimensions, but may result in a road of undesirable dimensions because of inaccuracy associated with the nozzle 137 and fabrication system in general as described herein.

The program 981 includes multiple fabrication instructions. For example, in one embodiment, the program 981 includes a first fabrication instruction to fabricate a first road 941 (first path of layer of material) on the component 182; the program 981 includes a second fabrication instruction to fabricate a second road 942 (second path of layer of material) on the component 182; the program 981 includes a third fabrication instruction to fabricate a third road 943 (third path of layer of material) on the component 182; and so on.

As mentioned, each of the original instructions in the program 981 are intended to produce a road of a particular length, thickness, width, etc. However, due to compression of material during fabrication, the original fabrication instructions 1721-1, 1722-1, 1723-1, etc., are prone to producing errors in the respective fabricated component 182 because the actual output of material 999-1 from the nozzle 937 is not equal to an expected amount of material 999-1 from the nozzle 937. In other words, based on the compression of the material 999 in the flow path 970, the output of the material 999-1 from the outlet 919 to fabricate the component 182 is different than as intended.

Based on the simulation via simulator 1710, and the determination of compression of the material 999 in the known volume of the flow path 970 during simulated fabrication of the component 182 (object) using the fabrication instructions in program 981, and/or corresponding intended dimensions of producing roads in component 182, the simulator 1710 and/or instruction generator 1720 modifies the original fabrication instructions 1721 (such as fabrication instructions 1721-1, 1721-2, 1721-3, etc.,) to produce the program 982 of fabrication instructions (such as instructions 1722 including 1722-1, 1722-2, 1722-3, etc.).

Thus, the fabrication instructions 981 are either modified to produce fabrication instructions 982 or the simulator 1710 or instructions generator 1720 produces the program 982 to include appropriate fabrication control instructions using printing system 933 or a replica of same to produce the component 182. The fabrication instructions of program 982 provide appropriate compensation to the original instructions (program 981 or definition) such that the component 182 is produced in accordance with desired dimensions via multiple roads.

As a further example embodiment, the simulator 1710 can be configured to determine appropriate compensation (due to the determined compression/decompression of material 999 in the flow path 970) for each generated road and produce a corresponding modified fabrication instruction in program 982.

For example, for a first road 941 of the component 182, the fabrication instruction 1721-1 includes control information (such as amount of flow rate of material 999 into the inlet 925, exact movement of the nozzle in 3D space, etc.) to create the first road 941 of the component 182 (3D printing component). The fabrication instruction 1721-1 or corresponding definition intends to create road 941 to have certain dimensions (such as length, width, and thickness or height). During simulation, the simulator 1710 determines an amount of compression (i.e., expansion or contraction) of a volume associated with material 999 in the flow path 970 associated with execution of the corresponding fabrication instruction 1721-1. As mentioned, the original fabrication instruction 1721-1 is prone to creating a road 941 of the component 182 that does not have the desired dimensions as intended by the fabrication instruction 1721-1. Via simulator 1710, during simulation, based on the identified amount of compression associated with material 999 in the flow path 970 (such as determined expansion or contraction of material 999 during a course of simulated execution of the instruction 1721-1 and corresponding simulated fabrication via printing system 933), the simulator 1710 determines appropriate adjustments that need to be made to the original fabrication instruction 1721-1 in order to produce the road 941 of intended dimensions. This can include modifying one or more control parameters (such as flow rate of material 999 from source 188 through inlet 925) associated with the original fabrication instruction 1721-1 such that the output of material 999-1 from the outlet 919 of nozzle 937 for the corresponding adjusted control instruction 1722-1 produces the respective first road of component 182 with the dimensions as intended by original fabrication instruction 1721-1. In other words, the replacement fabrication instruction 1722-1 (which replaces fabrication instruction 1721-1 and provides compensation of compression that takes into account the corresponding errors of original fabrication instruction 1721-1 and print system 933) to control the nozzle 937 and material 999 into the inlet 925 results in producing the first road 941 of desired dimensions. Thus, the adjusted or newly generated fabrication instructions 1722-1 that replaces the original fabrication instruction 1721-1 results in fabrication of the road 941 with proper dimensions. Thereafter, when any of the printing systems 1751, 1752, 1752, etc., (i.e., printing systems 1751, 1752, 1752 are replicas of printing system 933) executes the instruction 1722-1, these respective systems reproduce the rendition of the first road 941 of the corresponding generated rendition of component 182 to be of the intended dimensions without having to repeat a process of providing compensation for the compression associated with the material used to physically produces such components. In one embodiment, because the printer system 1751 implements the same nozzle 937 as the simulated printer system via the simulator 1710, the compensation of material compression is the same in the 3D printer system 1751, resulting in a precise and accurate fabrication of the rendition of the object 182 with intended dimensions using instruction 1722-1.

For a road 942 of the component 182, the fabrication instruction 1721-2 includes control information (such as amount of flow rate of material 999 into the inlet 925, exact movement of the nozzle in 3D space, etc.) to create the road 942 of the component 182 (3D printing component). The fabrication instruction 1721-2 intends to create road 942 to have certain dimensions (such as length, width, and thickness or height). During simulation, the simulator 1710 determines an amount of compression (i.e., expansion or contraction) of a volume associated with material 999 in the flow path 970 associated with execution of the corresponding fabrication instruction 1721-2. As mentioned, the original fabrication instruction 1721-2 is prone to creating a road 942 of the component 182 that does not have the desired dimensions as defined by or intended by the fabrication instruction 1721-2. Via simulator 1710, based on the identified amount of compression associated with material 999 in the flow path 970 (such as determined expansion or contraction of material 999 during a course of simulated execution of the instruction 1721-2 and corresponding simulated fabrication), the simulator 1710 determines appropriate adjustments that need to be made to the original fabrication instruction 1721-2 (such as flow rate, temperature, etc.) in order to produce the road 942 of intended dimensions. This can include, based on estimated compression associated with the material 999 during simulation, modifying one or more control parameters (such as flow rate of material 999 from source 188 through inlet 925) associated with the original fabrication instruction 1721-2 such that the output of material 999-1 from the outlet 919 of nozzle 937 for the corresponding adjusted control instruction 1722-2 produces the respective road 942 of component 182 with the dimensions as intended by original fabrication instruction 1721-2. In other words, the replacement fabrication instruction 1722-2 (which replaces fabrication instruction 1721-2 and provides compensation that takes into account the corresponding errors of original fabrication instruction 1721-2 and print system 933) which is used to control the nozzle 937 and material 999 into the inlet 925 results in producing the road 942 of desired dimensions. Thus, the adjusted or newly generated fabrication instructions 1722-2 that replaces the original fabrication instruction 1721-2 results in fabrication of the road 942 with proper intended dimensions. When any of the replica printing systems 1751, 1752, 1752, etc., (i.e. replicas of printing system 933) executes the instruction 1722-2, these respective systems reproduce the rendition of the road 942 of the corresponding generated rendition of component 182 (note that printing system 1751 is a replica of printing system 933 and physically produces rendition 182-1; printing system 1752 is a replica of printing system 933 and physically produces rendition 182-2; printing system 1753 is a replica of printing system 933 and physically produces rendition 182-3; etc.) to be of the intended dimensions of road 942 without having to repeat a process of providing compensation for the compression associated with the material used to physically produces such components. In one embodiment, because the printer systems 1751, 1752, 1753, etc., each implement the same nozzle 937 as the simulated printer system 933 via the simulator 1710, the compensation of material compression as captured by program 982 is the same in these 3D printer systems 1751, 1752, 1753, etc., resulting in a precise and accurate fabrication of the rendition of the object 182 with intended dimensions when executing fabrication instruction 1722-2.

Additionally, for a road 943 of the component 182, the fabrication instruction 1721-3 includes control information (such as amount of flow rate of material 999 into the inlet 925, exact movement of the nozzle in 3D space, etc.) to create the road 943 of the component 182 (3D printing component). The fabrication instruction 1721-3 intends to create road 943 to have certain dimensions (such as length, width, and thickness or height). During simulation, the simulator 1710 determines an amount of compression (i.e., expansion or contraction) of a volume associated with material 999 in the flow path 970 associated with execution of the corresponding fabrication instruction 1721-3. As mentioned, the original fabrication instruction 1721-3 is prone to creating a road 943 of the component 182 that does not have the desired dimensions as intended by the fabrication instruction 1721-3. Via simulator 1710, based on the identified amount of compression associated with material 999 in the flow path 970 (such as determined expansion or contraction of material 999 during a course of simulated execution of the instruction 1721-3 and corresponding simulated fabrication), the simulator 1710 determines appropriate adjustments that need to be made to the original fabrication instruction 1721-3 (such as flow rate, temperature, etc.) associated with the printing system 933 in order to produce the road 943 of intended dimensions. This can include, based on estimated compression associated with the material 999, modifying one or more control parameters (such as flow rate of material 999 from source 188 through inlet 925) associated with the original fabrication instruction 1721-3 such that the output of material 999-1 from the outlet 919 of nozzle 937 for the corresponding adjusted control instruction 1722-3 produces the respective road 943 of component 182 with the dimensions as intended by original fabrication instruction 1721-3. In other words, the replacement fabrication instruction 1722-3 (which replaces fabrication instruction 1721-3 and provides compensation that takes into account the corresponding errors of original fabrication instruction 1721-3 and print system 933) to control the nozzle 937 and material 999 into the inlet 925 results in producing the road 943 of desired dimensions. Thus, the adjusted or newly generated fabrication instructions 1722-3 that replaces the original fabrication instruction 1721-3 results in fabrication of the road 943 with proper intended dimensions using any other replica printing system. For example, when any of the replica printing systems 1751, 1752, 1752, etc., (i.e. replicas of printing system 933) executes the instruction 1722-3, these respective systems reproduce the rendition of the road 943 of the corresponding generated rendition of component 182 to be of the intended dimensions of road 943 without having to repeat a process of providing compensation for the compression associated with the material used to physically produces such components. In one embodiment, because the printer systems 1751, 1752, 1753, etc., each implement the same nozzle 937 as the simulated printer system 933 via the simulator 1710, the compensation of material compression is the same in these 3D printer systems 1751, 1752, 1753, etc., resulting in a precise and accurate fabrication of the rendition of the object 182 with intended dimensions using the fabrication instruction 1722-3.

Thus, via simulation, and generation of the fabrication instructions, the compensation as described herein as a result of compression of material 999 is built into the fabrication instructions 1722 (such as program 982) themselves as opposed to having to monitor parameters such as temperature, pressure, etc., of the material 999 in the flow path 970 to adjust the input flow rate into inlet 925 in real time during fabrication renditions of the component 182.

Because the newly generated program and corresponding instructions include appropriate control rules (fabrication instructions 1722, providing for compensation due to expansion/contraction of material 999 in the flow path 970 of nozzle 937 during generation of a road) to generate the component 182 with desired dimensions, the generated program 982 and corresponding fabrication instructions can be used to fabricate renditions of the component 182 via other 3D printing systems using the same nozzle 937 and print setup as previously discussed.

Note that simulated fabrication of the component (via simulator 1710) is shown by way of a non-limiting example embodiment only. The simulation as described herein can be replaced with printing system 933 that actually fabricates component 182 using the program 981. In such an instance, the instruction generator 1720 records the flow rate adjustments due to compression of material during generation of the component 182. The recording of exact operations (such flow rate adjustments, movement of nozzle, etc.) as used to produce each road of component 182 are recorded and captured as program 982, which are then implemented by each of the replica printing systems 1751, 1752, 1753, etc., to reproduce renditions of the component 182 in an exact same manner or nearly identical manner (flow rate control of material 999 into and out of flow path 970, movement of the nozzle, etc.) that the printing system 933 implemented to create the original component 182. Thus, the printing system 933 and instruction generator 1720 can be configured to produce program 982 indicating the operations implemented by the printing system 933 to produce the component 182.

Surprisingly, the simulation of the 3D printing process was found sufficiently accurate to provide improved control by simulating and correcting conventional machine instructions. The method steps for the 3D printing simulation are provided in FIG. 17 (illustrating a method such as flowchart 1700).

At step 17a, the simulation is initialized. This step includes reading the entirety of the machine program, setting simulation options, and initializing the finite element mesh to virtually produce a respective 3D component 182. While not required to practice the invented method, reading the entirety of the machine program prior to simulating its instructions provides the benefits of (1) being able to close the file prior to the simulation, and (2) knowing the number and range of instructions so as to pre-allocate memory. Simulation options are typically defined prior to the start of the simulation and may include Boolean flags indicating the use of constant road widths, rounding corners, redoing retractions, speeding up the process, redoing accelerations, minimizing the file size, graphing the results, visualizing the results, and simulating the part properties. The use of the word “redoing” here means that the machine instructions (typically provided by a pre-processor or “slicer” that converts the part geometry to a set of machine instructions for printing) is over-written by the results of the simulation. The implementation literally replaces the machine instructions, for example, by varying the feed rates for the print velocity and extruder to manage compressibility (compression). As another example, the simulation also supports the over-writing of feed rates with consideration of compressibility (compression) to enable much faster and higher quality printing as shown by latter validation examples. Likewise, the simulation can inspect the viscosity of the material to ensure that the material being processed is, in fact, processable at the specified conditions and re-specify the processing conditions (such as temperature and print speeds) to ensure a robust printing process. For example, if an ABS material was specified to print at a hot end temperature of 180 C and a flow rate of 20 cubic millimeters per second, the simulation would estimate the melt pressures to be excessive and recommend a hot temperature above 230 C such as 240 C.

Method step 17a also includes initializing the finite element mesh. The requirements for this step are related to the need for different iterative control loops as previously described with respect to method step 14j. In the simulation, the process states are updated at each time step. As such, a single machine instruction, for example, to print a road of 40 mm at a print speed of 20 mm/s would be unsuitable for simulation. The reason is that the simulation would be unable to directly model the dynamics of the process during the 2 s duration of this instruction's execution. As such, the preferred method is to split each machine instruction into a series of sub-instructions wherein each sub-instruction corresponds to a finite element. This discretization is performed upon the reading of the machine instructions. The discretization is performed such that the resulting element length is less than some maximum length and the resulting print time step is less than some maximum time step (whichever is smaller). In the implementation, the maximum element length is 1 mm and the maximum time step is 0.1 s. For illustrative purposes, suppose that a set of machine instructions requires 2 hours printing at an average speed of 20 mm/s. Then the total printed length would be 144,000 mm across 7200 s. The minimum number of elements would be the greater of 144,000 elements for the length and 72,000 elements for the time. Typically, the number of elements would actually be greater than 144,000 elements given the varying print velocities, printed road lengths, and rounding to a whole number of elements in a printed road segment. The preferred maximum element length, preferred maximum time step, and exemplary calculations are just provided for illustrative purposes and not meant to limit the application of the invented methods. In implementation, the inventor has found that element lengths from 0.1 to 10 mm are typically acceptable as are time steps from 0.01 to 2 s. Generally smaller values of element lengths and time steps provide improved accuracy of the results but require substantially greater computation times. It should be understood that the term “finite element” is intended to just mean a discretization of a physical domain, and not require a specific methodology such as the Galerkin method or specific type of shape functions. Accordingly, the methodology of FIG. 17 can be applied to different computational approaches including but not limited to the finite difference method, finite element method, finite volume method, and others.

After the simulation is initialized in operation 17a, a pointer is created to the current machine instruction for simulation. If the instruction does not involve movement of a print nozzle, then the simulation just records any changes in machine settings such as temperature or feed rates of material 999 in computer memory for subsequent computations. If the step involves movement, then the flow rate from the extruder (represented by the variable QE) is simulated at step 17b as the sum of the extrudate length (represented by E) and extrudate correction (represented by EC, initially set to 0 but subsequently calculated as later described) multiplied by the cross-section area of the filament (represented by AF) divided by the time step (Dt).

The process states are then simulated at step 17d based on the shear rate and viscosity properties of the material being processed as previously described with respect to FIGS. 10 and 11. The flow rate due to changes in compressibility (compression) (represented by QC) is then estimated at step 17e. The preferred method as implemented discretizes the melt channel into a series of segments of varying length, thickness, and width for generally rectangular sections or segments of varying length and diameter for generally cylindrical segments. The temperature and pressure in each segment of the flow channel is estimated either by simulation or linear interpolation based upon the acquired process states. The specified volume (represented by SV) is then calculated based on the double domain Tait equation or a look-up table of SV based on experimental characterization as previously described with respect to FIG. 12. The flow rate due to changes in compressibility (compression), QC, is then calculated as QC=V*(SV(t−Dt)/SV(t)−1)/Dt wherein V represents the volume of each flow segment and t represents the current time. While other estimation methods for the compressible flow can be used, this particular implementation has provided suitably accurate and easy to compute. Compared to the previous estimation QC provided with respect to analysis of FIG. 26, the formula in the program involves fewer calculations of the specific volume and also enhanced numerical stability.

The total flow rate (represented by Q) of the flowable material 199 is then calculated as the sum of QE and QC at step 17e. The linear velocity of the hot end (represented by S) is then calculated based on the X, Y, and Z velocities of the hot end relative to the bed as specified by the input machine instruction. Given the fact that the pressure of the material (flowable material 199) being monitored and processed is a function of the flow rate from the extruder as well as the flow rate due to compressibility (compression), a convergence loop 17z is required to converge the solution. The method of successive over relaxation was implemented with typical relaxation factors of 0.9. The number of convergence iterations is tracked during the simulation of each sub-instruction, and the amount of relaxation is automatically increased should the pressure not converge. Typically, between 20-100 iterations are required to converge but the number of iterations can increase substantially when stepping from relatively low flow rates (like 0 cubic millimeters per second) to relatively high flow rates (like 20 cubic millimeters per second). In such cases, convergence may require thousands of iterations with an increase of the relaxation factor. The resulting width of the extrudate (such as flowable material 199 represented by W) is then calculated at step 17f as the total flow rate divided by the linear velocity, S, and the layer height (represented by H).

The dashed lines in FIG. 17 adjacent step 17h indicate an optional corrective action to update the filament position based on the compressible flow rate, QC. The extrudate correction, EC, is equal to the opposite of the product of QC and Dt divided by AF as these terms have been previously defined. While corrective actions are typically desired, the method of FIG. 17 is still useful even without corrective action to predict the width based on the acquired process states and estimated compressible flow. While the method of FIG. 17 has focused on width, it is understood that other part properties such as filled volume, void fraction, part dimensions, and layer strength may also be readily modeled and controlled.

The data, including the melt pressure and road widths and melt temperature if available, can be stored as a function of time or position at step 17g. The data may be more compactly stored as a vector of the total print length (sum of X, Y, Z, and E moves) wherein new elements of the vector are only appended when the melt pressure and road widths and melt temperatures vary in a significant amount from the last stored element of the vector. The magnitude of the process change to trigger data storage will vary by application requirements. A typical specification may be 0.1% of the mean so some typical values for melt pressure, road width, and melt temperature might be 0.002 MPa, 0.005 mm, and 0.1 degree Celsius. Such a vector storage approach can compact the data by more than a hundred times while maintaining significant data fidelity. Other data compression methods such as Lempel-Ziv (LZ) compression can also or alternatively be applied.

The data may also be analyzed or reported at step 17g. The analysis may include statistical analysis such as described by the inventor in the article Kazmer, D. O., S. Westerdale, and D. Hazen. “A comparison of statistical process control (SPC) and on-line multivariate analyses (MVA) for injection molding.” International Polymer Processing 23, no. 5 (2008): 447-458. Alternatively, the analysis may include a finite element simulation of the completed process including flow, heat transfer, and stress relaxation such as described by the inventor in the article Fan, Bingfeng, David O. Kazmer, Wit C. Bushko, Richard P. Theriault, and Andrew J. Poslinski. “Birefringence prediction of optical media.” Polymer Engineering & Science 44, no. 4 (2004): 814-824 as well as the article Fan, Bingfeng, David O. Kazmer, Wit C. Bushko, Richard P. Theriault, and Andrew J. Poslinski. “Warpage prediction of optical media.” Journal of Polymer Science Part B: Polymer Physics 41, no. 9 (2003): 859-872. While these latter references were developed for injection molding, the underlying concepts are applicable to the described injection printing process.

After each planned machine instruction, a check is performed at step 17j to see if the set of the instructions is complete. If not, the time is updated by the time step Dt and the method continues with the next machine sub-instruction at step 17b. When all sub-instructions are complete to represent a machine instruction, the same outer loop of 17i is used to acquire the next machine instruction and continue the simulation. In the simulation, the inventor has found that updating the process states and control actions at a frequency around 10 Hz is suitable for both simulation and control purposes. This 10 Hz frequency is provided for illustrative purposes but will vary with the size of the part being printed, material properties, and processing conditions.

When the set of instructions is complete, a final report may be provided at step 17k. This final report may provide a summary of the simulated process and estimated part properties including statistics thereof. Based on these statistics and the part property specifications, a determination may be made as to the suitability of the process plan for the printed part. For example, the process plan may be deemed satisfactory or unsatisfactory or provisionally satisfactory with flagged concerns. Alternatively, the estimated part properties may be graded against the part property specifications. A colored contour map showing the locations of potential issues may be provided wither in graphical form or as a matrix of numerical values. For example, the matrix of numerical values containing local dimensions, distortion due to shrinkage or warpage, modulus, stress, or strength properties may be mapped to a different finite element mesh suitable for structural, thermal, or other mechanistic simulation.

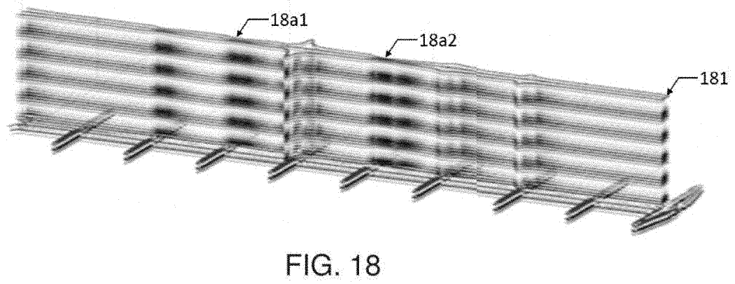

The order and details of the method steps in FIGS. 14 and 17 can be altered without significantly changing the functionality or result of the described method. For example, a preferred implementation continually write the revised machine program as the machine program is being read and processed such that block 17k is actually a part of block 17g or precedes block 17j. This preferred implementation provides the benefit of using the same loop structure to read the original machine program and write the revised machine program, such that a redundant programming loop for outputting the revised machine program can be avoided. FIG. 18 provides a 3D vector line plot 181 in XYZ space for the road widths (such as multiple layers of deposited flowable material 199 to create object 182) estimated by the implemented methods of FIG. 17 applied to the validation test part of FIG. 13 using the same ABS at a hot end temperature of 230 C, bed temperature of 100 C, and nominal print speeds plotted in FIG. 13. Similar to the physical part plotted in FIG. 13, the simulation result suggests substantially thinner printed part at locations 18a1 and 18a2. Likewise, decreasing the velocity results in excess flow out of the nozzle and thicker part such as in the intermediate locations between 18a1 and 18a2. As shown, a width of the respective layers of deposited flowable material vary over a respective length of plot 181. A contour plot 16c of the simulated widths is also provided in FIG. 16; the mean and standard deviation of the conventionally printed part is estimated to be 0.531 mm and 0.197 mm, respectively. These validation results suggest that the invented methods for predicting the road widths of dispensing flowable material 199 from nozzle orifice 19 can provide suitable corrective actions in general 3D printing applications to ensure that respective widths of the deposited material along its length are substantially a same value or are desired values at each of multiple points along the deposition path of flowable material 199 onto object 182.

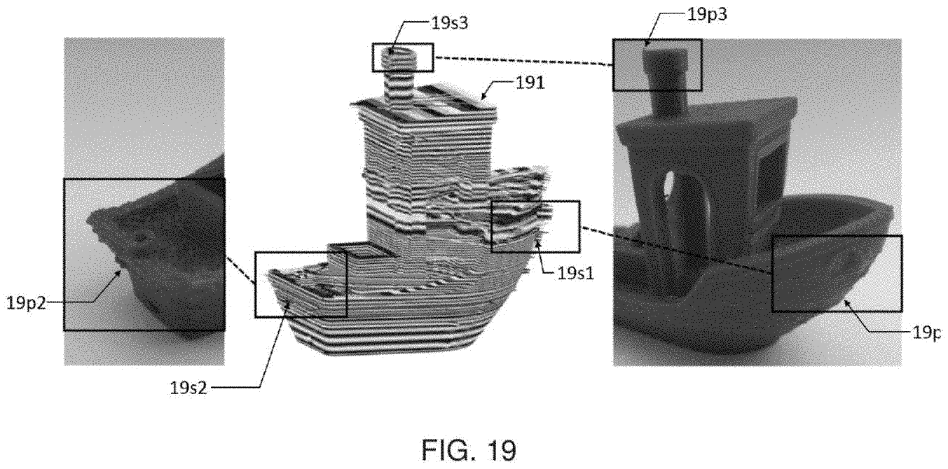

A surprising finding is that the described approach for characterizing and correcting the compressibility (compression) effects are quite robust and are generally applicable in 3D printing. Indeed, the inventor has found that the use of this correction algorithm has significantly improved the print quality of all machine programs yet tested. Its use thus allows increases of printing speed without compromising the quality of the printed components. As an example, the methodology of FIG. 17 was applied to simulate the printing of the benchmark part “3DBenchy” using the same ABS at a hot end temperature of 230 C, bed temperature of 100 C, and nominal print speed of 20 mm/s. The resulting vector line plot 191 is shown in FIG. 19. It is observed that the simulation predicts surface asperities such as 19s1, 19s2, and 19s3 associated with the execution of the machine commands including the compressible flow effects associated with starting, stopping, and varying the print velocity. Potently, the location and magnitude of the predicted surface asperities closely match the observed surface asperities such as 19p1, 19p2, and 19p3 on the printed part. These validation results also suggest that that the methods as described herein for predicting the road widths (of deposited and cured flowable material 199 such as a solid) can provide suitable corrective actions in general 3D during printing applications.

Returning to the methodology of FIG. 17 and specifically step 17k, the simulation can output a revised set of machine instructions for use with a 3D printer if corrective actions are specified in the simulation options. The 3D printer may be a stock printer and need not be provided with any of the apparatus described by FIGS. 1-8. For example, the inventor has validated the methods using not only a Creality Ender 5 fitted with the instrumented hot end, but also a stock Qidi Xpro with a stock nozzle and controller. The inventor has found that the corrected machine instructions provided by the simulation work equally well for both the machine setups.

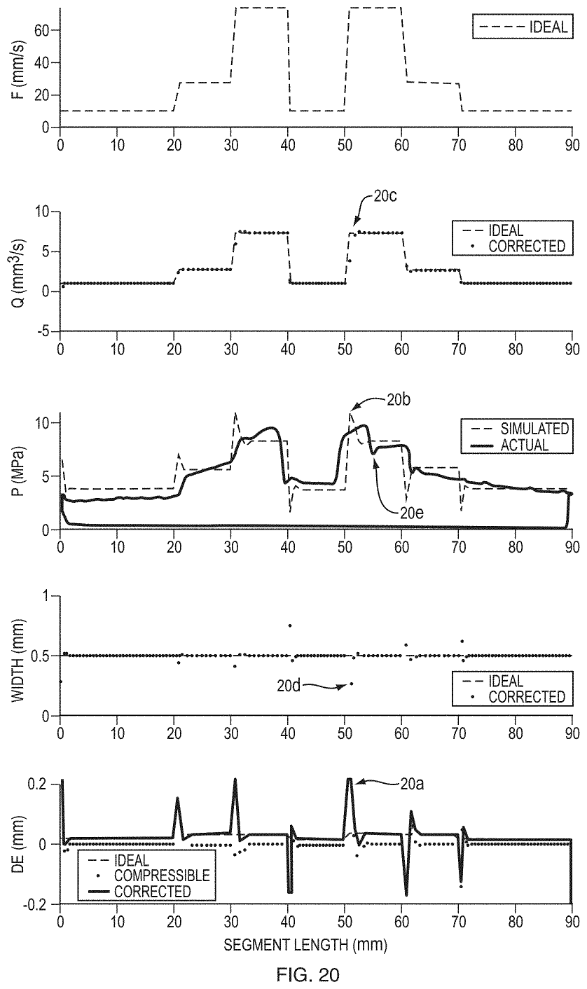

For validation of the simulation-based control methods as described herein, the methodology of FIG. 17 applied to the validation test part of FIG. 13 using the same ABS at a hot end temperature of 230 C, bed temperature of 100 C, and nominal print speeds plotted in FIG. 13. The simulation results including the extruder stepping (DE) are provided in FIG. 20 as a function of the print length in 1 mm increments associated with each machine sub-instruction as previously described with respect to FIG. 17. In FIG. 20, the subplots from to bottom correspond to the print speed (referred to as F), the flow rate (referred to as Q), the pressure of the material being processed (referred to as P), the width of the printed road, and the filament stepping (referred to as DE).

It is observed from the results of FIG. 20 that the simulation outputs corrective control actions as shown in the bottom plot for DE to compensate the flow rate effects due to compressibility (compression). As a result of these control actions, the simulated pressure P of the material being processed purposefully overshoots the ideal step response for an incompressible material. The reason is that an added mass of the material (flowable material 199) being processed is required to compress the volume of the material (flowable material 199) in the melt channel 1 of the hot end in order to achieve the desired step response in the volumetric flow rate out of the nozzle orifice 19. For example the corrected control action 20a provides significantly more material than at a location of 50 mm as the print speed F increases from 10 to 73 mm/s. This added material causes a sudden increase in pressure P at 20b, whereby the flow rate Q at 20c is increased. Even with this corrective control action, the predicted width at 20d is less than the ideal width of 0.5 mm.

For comparison purposes, the pressure P of the material being processed for the printing with the simulation-based control actions is plotted as the bold curve in the middle plot of FIG. 20. It is observed that the implemented control actions for DE provide a significantly improved response compared to the more rounded pressure trace plotted in FIG. 15 for the control action based on the pressure and accelerometer. The reason is that the specified flow rate for the extruder in FIG. 15 follows the smoother velocity profile as sensed from the accelerometer. By comparison, the simulation-based control actions of FIG. 20 essentially provide the corrective control action in a single time step based. The reason is that the simulation can model the pressure required to provide the desired output flow rate, and so provide a feedforward mechanism to provide the corrective action in parallel with changes in the velocity and other printing process conditions.

The measured thicknesses of the printed part with corrective control actions based on the simulation is plotted in the contour plot 16e of FIG. 16. The statistics are provided in Table 2, indicating a mean of 0.527 mm and 0.068 mm, respectively. It is noted that the control actions based on the simulation according to the methodology of FIG. 17 outperform the control actions based on the implemented pressure and accelerometer according to the methodology of FIG. 14. The expected reason are inaccuracies based on the sensed velocity profile from the accelerometer. It is expected that the results for the control actions based on sensed feedback will outperform the control actions based on simulation given improved velocity feedback. Accordingly, the velocity feedback based on the ICM-20948 accelerometer can be readily replaced with an improved accelerometer. Alternatively, the ICM-20948 accelerometer may be replaced with a laser interferometer for sensing the absolute position of the hot end from which the velocity may be derived. Regardless, both methodologies of FIGS. 14 and 17 outperform conventional printing without consideration of compressibility (compression).

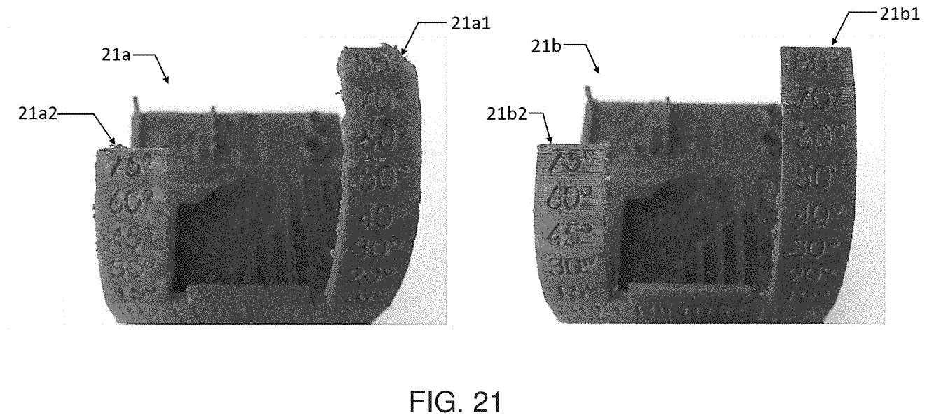

As further validation as to the simulation-based control actions, a second benchmark print was made with and without corrective control action. Specifically, the benchmark “All-In-One 3D Printer Test” by majda107 was printed using the same ABS at a hot end temperature of 230 C, bed temperature of 100 C, and nominal print speed of 20 mm/s. The resulting print 21a without corrective control action is shown in FIG. 21a. It is observed that the are portions of the part that are missing such as at 21a1 as well as stringing such as at 21a2. The reason for the missing portion is that the printing proceeds from right to left on the 80 degree incline. The re-starting of the material at location 21a1 is too slow owing to compressibility (compression) effects. As a result, the material does not adhere to the edge but globs below the bottom of the top face. While not shown in FIG. 21, a side view would show an abnormally thick, globular section. The stringing at location 21a2 results from a stopping of the material being processed at relatively high pressure. In this case, the cessation of the material results in some drool out of the nozzle that causes the observed defect.

The application of the simulation to provide corrective control actions results in a printed part such as object 182 similar to that shown in 21b in FIG. 21. Given the success of this print, the simulation was provided a set of options to override the original machine instructions to increase the nominal print speed from 20 mm/s to 50 mm/s. The resulting part is shown at 21b in FIG. 21. It is observed at 21b1 and 21b2 that the deposition issues 21a1 and 21a2 have been resolved. For purposes of full disclosure, the simulation details with and without control and at different print settings are provided in TABLE 3 wherein case 1 corresponds to part 21a and case 3 corresponds to part 21b. It is observed that the simulation time for the 3D printing process is on the same order of magnitude as the actual printing time, and that the calculation of the control actions for compressibility (compression) compensation of the flowable material 199 significantly increase the computation times. However, as the results have shown, the use of the disclosed methods can significantly increase the quality of printed product while also significantly decreasing printing times. Accordingly, it is well worth performing the simulation for many 3D printing applications where the printed part quality is important as well as for production applications where the printing time is important.

TABLE 3
Simulation details for benchmark case of FIG. 20

| | Con- | Road | Road | Print | Print | CPU | Hot End |
|---|---|---|---|---|---|---|---|
| Case | trol | Width | Height | Speed | Time | Time | Simulations |
| 1 | No | 0.4 mm | 0.2 mm | 20 mm/s | 17,281 s | 3,854 s | 58,589,474 |
| 2 | Yes | 0.4 | 0.2 | 20 | 17,281 | 11,999 | 184,119,678 |
| 3 | Yes | 0.5 | 0.2 | 50 | 6,337 | 13,441 | 202,594,631 |

A surprising finding is that the described approach for characterizing and correcting the compressibility (compression) effects can be applied to other machine programs for use by a printer. Indeed, the inventor has found that the use of this correction algorithm has significantly improved the print quality of all machine programs yet tested. The described methods of FIGS. 14 and 17 can thus allow increased printing speed without compromising the quality of the printed components.

The apparatus of FIGS. 1-8 and the methods of FIGS. 14 and 17 were developed concurrently and are intended to be used in conjunction. However, they may be practiced separately for varying reasons as described. A benefit of practicing them together is the reduction of uncertainty and variation, especially in production applications where a large quantity of products is desired.

For use in production, it is beneficial to use the instrumented apparatus of FIGS. 2-8 with the implemented melt channel to achieve higher melting capacity and more uniform processing temperatures as well as high fidelity monitoring of process states. The monitored process states are useful not only for control purposes as discussed with respect to FIG. 14, but also for part qualification and quality assurance as previously described. Given the fact that there are many potential process states and product quality attributes of potential interest, it is beneficial to calculate aggregate figures of merit during the printing process so that a statistical determination can be made as to the acceptability of a given printed part.

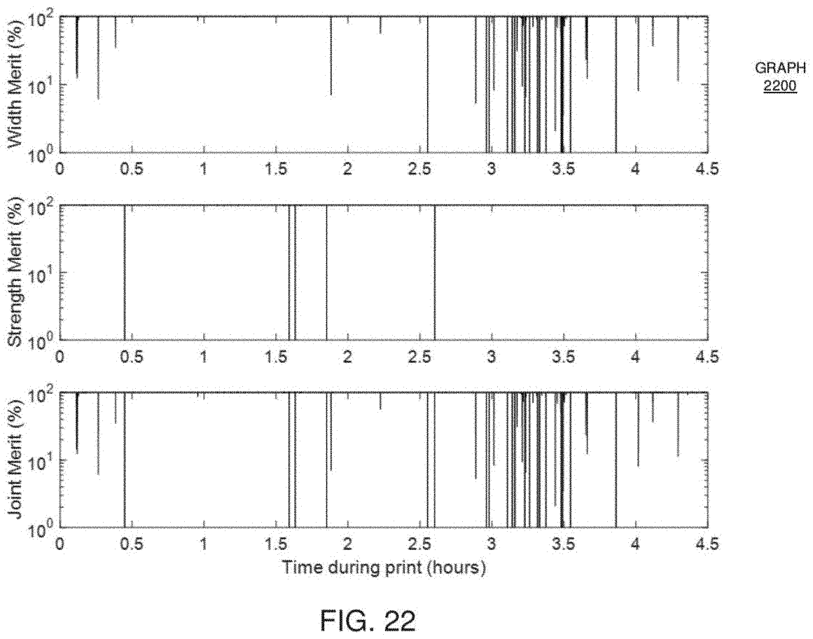

One reasonable aggregate figure of merit is the joint probability for all specifications being satisfied. For example, suppose that the road width is specified as being between 0.3 and 0.7 mm with another specification for the bond strength to be between 60 and 100% of the yield strength of the material being processed. The statistical likelihood of each quality attribute being satisfied may be calculated by the normal cumulative distribution function (for example, as with the normcdf function in Matlab). FIG. 22 provides some illustrative figures of merit for the 3DBenchy simulation of FIG. 19 based on the likely acceptability of the width and strength as a function of the time during the print. The joint merit in the bottom subplot is calculated as the product of the separate figures of merit for the width and strength.

To reduce the amount of data to even in FIG. 22 (illustrating a graph 2200), the statistics on the figures of merit can be calculated such as those shown in TABLE 4. For each of the plotted figures of merit, the mean and standard deviation is calculated. Here, the calculated mean figure of merit is simply the arithmetic mean but the geometric mean and other measures can likewise be calculated such as described by the inventor in “Kazmer, D. and Roser, C., 1999. Evaluation of product and process design robustness. Research in Engineering Design, 11(1), pp. 20-30.” The process capability index for each figure of merit can be calculated as the inverse of the normal cumulative distribution function (such as by the norminv function in Matlab). Specifically, the process capability index (referred to as CP) can be calculated as CP=−norminv(1−P)/3 where the variable P is the calculated mean figure of merit. The number 3 in the denominator represents the standard process capability commonly used in manufacturing to represent 3 standard deviations from the closest specification limit. If a standard process capability index of 1 is required, then the process for printing the 3DBenchy should be rejected since the joint figure of merit is less than 1. Inspection of the results indicates that the reason for rejection is a lack of acceptable strength.

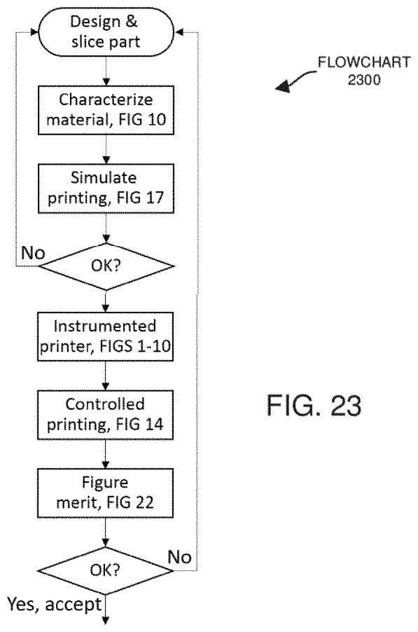

TABLE 4
Figures of merit per FIG. 23

| | | | | Process |
|---|---|---|---|---|
| | | | Standard | capability |
| Case | Figure of merit | Mean | deviation | index |
| 1 | Acceptable Width | 99.9908 | 0.89 | 1.253 |
| 2 | Acceptable Strength | 99.8167 | 4.28 | 0.972 |
| 3 | Joint | 99.8075 | 3.37 | 0.967 |

Many applications seek “six sigma” quality levels, which require six standard deviations of variation between all quality attributes and their closest specification limit. The described methodology with respect to FIG. 22 supports the six sigma approach wherein the process capability index should be greater than 2. At this quality level, the process for printing the 3DBenchy should be rejected for lack of both acceptable width and acceptable strength.

It is emphasized that the figures of merit calculated in FIG. 22 are solely provided for illustrative purposes. Different figures of merit based on different quality attributes may be readily implemented. The figures of merit may also be based on other performance measures other than statistical yields of acceptability.

A general methodology for practicing the described inventive system is provided in FIG. 23 (illustrating a method such as flowchart 2300). As indicated, the method begins with design including the specification of the product geometry, material to be processed, and anticipated process conditions. The candidate material may be characterized using the instrumented printer of FIGS. 1-10 and material characterization methods of FIGS. 11 and 12. The printing process may then be simulated per the methodology described for FIG. 17. If the printing process is deemed infeasible or the estimated part properties are deemed unacceptable, then additional design iterations may be performed including the selection of alternative candidate materials.

Otherwise, the machine instructions including the corrective actions of the simulation may be used with the instrumented printer of FIGS. 1-10 along with the material characterization data of FIGS. 11 and 12. The printing process may proceed using control actions based on process feedback per the methodology described for FIG. 14. As the printing process proceeds, figures of merit may be calculated as described for FIG. 22. If the printing process is deemed infeasible or the estimated part properties are deemed unacceptable, additional design iterations may be performed to provide more robust products, processes, and materials. For acceptable printed parts, the process fingerprints and figures of merit may be stored for qualification, quality assurance, and continuous improvement purposes.

The foregoing embodiments were provided for demonstrative purposes only and not intended to limit the injection printing method in any way. Many different designs, materials, and processes are thus enabled by the claimed invention. For example, the presented examples were for an ABS material, but the invention has been also practiced for high impact polystyrene (HIPS) and polylactic acid (PLA) to produce various part geometries and at varying processing temperatures and printing speeds. For these and other materials, the invented apparatus and methods can be directly applied including the apparatus as described for FIGS. 1-8 with and without instrumentation, acquisition of process states as described for FIGS. 9 and 10, characterization of viscosity and compressibility (compression) as described for FIGS. 11 and 12, corrective control based on process feedback as described for FIGS. 14 and 15, corrective control based on simulation as described for FIGS. 17 and 20, and production monitoring as described for FIGS. 22 and 23.

Note that further embodiments herein include a method and system for calibrating the compressibility (compression) correction. The implemented method includes, via the print system as described herein, printing a component at varying flow rates of material through a flow path. For example, FIG. 13 provides a photograph of a fixture and test part as well as a varying velocity profile used for validation of the described methods according to embodiments herein.

Embodiments herein further include, via the print system as described herein, observing melt pressures (such as via signal 955 at different times) of the material 999 in the flow path 970 as a function of flow rate. FIG. 15 provides acquired process states and resulting control signals for the validation of the part (i.e., printed component) and varying flow rates associated with FIG. 13.

Embodiments herein further include, via the print system as described herein, modeling a viscosity of the material as a function of shear rate based on the melt pressures as a function of the calculated flow rate of material 999. As an example, FIG. 11 provides the viscosity model as a function of shear rate and temperature for the acquired pressure data (from signal 955) plotted in FIG. 10 according to embodiments herein. Also, in one embodiment, note that material constitutive viscosity models include a Newtonian model, power-law model, Cross model, Carreau model, and others with temperature dependence modeled according to Arrhenius and WLF forms.

Embodiments herein further include measuring dimensions of a printed road of the component. For example, FIG. 16 provides contour plots for the measured part thicknesses produced by conventional 3D printing as well as the methods of FIGS. 14 and 17 according to embodiments herein.

Embodiments herein further include adjusting the model coefficients for the volume and bulk modulus of the material 999 in the flow path 970. For example, as described herein, the instrumented apparatus can be used in a characterization methodology in which the inlet flow rates of a material 99 to a 3D printing apparatus (flow path 970) are varied in a controlled manner to observing the transient pressure as across a wide range of inlet flow rates for a material being processed. The material constitutive models, such as the Cross-WLF model for the viscosity and the double domain Tait equation for the compressibility (compression), are then used to estimate the transient pressure as a function of the varied inlet flow rates using models. The differences between the observed and estimated pressures are then be used to adjust or fit model coefficients for the viscosity and compression behavior of the material so that the observed and estimated behaviors coincide. These fitted material constitutive models are then be used for purposes of modeling and control of 3D printing processes as described according to subsequently described embodiments.

Additionally, as previously discussed, note that embodiments herein include 3D printing nozzles, hot ends, and methods for their use are described. Configurations as described herein provide for apparatus and methods that deliver (i) higher melting rates, (ii) improved processing consistency, (iii) faster printing speeds, (iv) improved printed product quality, and (v) quality assurance. Methods for on-line characterization of material viscosity and compressibility (compression) are provided using an instrumented apparatus. Methods for controlling the 3D printing process based on feedback from instrumentation as well as simulation are also described.

Thus, embodiments herein include printing a component at varying flow rates of material through a flow path; observing melt pressures of the material in the flow path as a function of flow rate; modeling a viscosity of the material as a function of shear rate based on the melt pressures as a function of flow rate; measuring dimensions of a printed road of the component; and adjusting the model coefficients for the volume and bulk modulus of the material in the flow path.

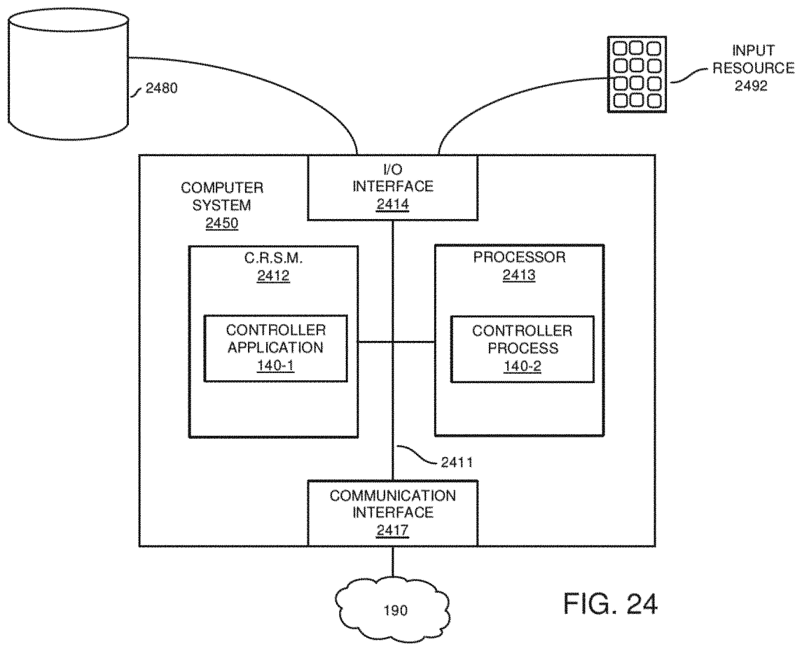

FIG. 24 is an example block diagram of a computer system for implementing any of the operations as previously discussed according to embodiments herein.

For example, note that any of the resources (such as controller 140, etc.) as discussed herein can be configured to include computer processor hardware and/or corresponding executable instructions to carry out the different operations as discussed herein via computer system 2450.

As shown, computer system 2450 of the present example includes an interconnect 2411 that coupling computer readable storage media 2412 such as a non-transitory type of media (which can be any suitable type of hardware storage medium in which digital information can be stored and retrieved), a processor 2413 (computer processor hardware), I/O interface 2414, and a communications interface 2417.

I/O interface(s) 2414 supports connectivity to repository 2480 and input resource 2492.

Computer readable storage medium 2412 can be any hardware storage device such as memory, optical storage, hard drive, floppy disk, etc. In one embodiment, the computer readable storage medium 2412 stores instructions and/or data.

As shown, computer readable storage media 2412 can be encoded with controller application 140-1 (e.g., including instructions) to carry out any of the operations as discussed herein.

During operation of one embodiment, processor 2413 accesses computer readable storage media 2412 via the use of interconnect 2411 in order to launch, run, execute, interpret or otherwise perform the instructions in controller application 140-1 stored on computer readable storage medium 2412. Execution of the controller application 140-1 produces controller process 140-2 to carry out any of the operations and/or processes as discussed herein. In other words, controller application 140-1 can be configured to execute operations as described herein to implement simulations, flow control, producing of a respective object 182, etc.

Those skilled in the art will understand that the computer system 2450 can include other processes and/or software and hardware components, such as an operating system that controls allocation and use of hardware resources to execute controller application 140-1.

In accordance with different embodiments, note that computer system may reside in any of various types of devices, including, but not limited to, a mobile computer, a personal computer system, wireless station, connection management resource, a wireless device, a wireless access point, a base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 2450 may reside at any location or can be included in any suitable resource in any network environment to implement functionality as discussed herein. In one embodiment, the control system 2450 can include or be implemented in virtualization environments such as the cloud.

Note again that techniques herein are well suited to facilitate redirection (such as handoffs) of wireless devices amongst wireless access points in a network environment. However, it should be noted that embodiments herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting. Rather, any limitations to the invention are presented in the following claims.

1. A method comprising:
sensing a pressure of a material in a flow path during a printing process of fabricating a component, the material outputted from the flow path to produce the component;
based on the pressure, estimating a volumetric change of the material in the flow path due to compression of the material during the printing process; and
varying an inlet flow rate of the material from a source into the flow path to compensate for the estimated volumetric change of material due to the compression.

2. The method as in claim 1, wherein estimating the volumetric change in the material in the flow path includes:
inputting the sensed pressure to a model that estimates the volumetric change of the material.

3. The method as in claim 1 further comprising:
receiving a temperature value indicative of a temperature of the material in the flow path; and
estimating the volumetric change of the material based on the temperature.

4. The method as in claim 1 further comprising:
estimating an output flow rate of the material from an outlet of a print nozzle of the flow path based on the estimated volumetric change.

5. The method as in claim 1, wherein varying the inlet flow rate of the material from the source into the flow path includes:
based on the estimated volumetric change of the material, adjusting the inlet flow rate of material into the flow path.

6. The method as in claim 5, wherein the adjusted inlet flow rate causes a flow rate of the material outputted from the flow path to be a target flow rate value.

7. The method as in claim 1 further comprising:
estimating the volumetric change of the material in the flow path due to compression of the material via a compression model.

8. The method as in claim 1, wherein the printing process is a 3D printing process, the method further comprising:
controlling movement of a nozzle in which the flow path resides, output of the material from the flow path and the nozzle producing a road on the component.

9-16. (canceled)

17. A method comprising:
sensing a melt pressure of material in a flow path during 3D printing of a component;
estimating a volumetric change due to compression of the material being processed with the sensed melt pressure; and
varying the volumetric flow rate of the extruded material to compensate for the volumetric change due to the compression of the material being processed.

18. A method comprising:
receiving first fabrication instructions to produce a component via a 3D printing process using a first printing system;
simulating the printing process via the first printing system, simulation of the printing process via the first printing system including:
i) estimating a pressure of a material in a flow path of a nozzle of the first printing system during the simulated printing process of fabricating the component, the material outputted from the flow path to produce the component;
ii) based on the estimated pressure, estimating a volumetric change of the material in the flow path due to compression of the material during the simulated printing process; and
iii) determining variations of an inlet flow rate of the material from a source into the flow path to compensate for the estimated volumetric change of material due to the compression; and
deriving second fabrication instructions from the simulation of the printing process, the second fabrication instructions providing compensation of the volumetric change of the material in the flow path due to compression of the material during the simulated printing process.

19. The method as in claim 18 further comprising:
executing the second fabrication instructions via a second printing system to fabricate a rendition of the component.

20. The method as in claim 19, wherein the second printing system is a replica of the first printing system.

21. A method of printing a component, the method comprising:
receiving a fabrication program of a planned printing process of fabricating the component via a print material;
simulating a melt pressure of the print material during the planned printing process;
simulating a volumetric change of the print material due to compression of the material during the planned printing process;
simulating an inlet flow rate of the print material into a during the planned process in order to compensate for the volumetric change due to compressibility; and
revising the planned machine program for the planned printing process in order to compensate for the volumetric change due to compressibility.

22. The method of claim 21, wherein the inlet flow rate is varied to control a printed road width.

23. The method of claim 21, wherein the estimated volumetric change due to compression of the material in the flow path supports a revision of the first fabricate instructions into the second fabrication instructions, the second fabrication instructions providing a faster printing process than the first fabrication instructions.

24-26. (canceled)

27. A method for printing a component, the method comprising:
estimating a melt pressure during a printing process;
estimating a volumetric change due to compressibility of the material given the estimated melt pressure; and
varying a volumetric flow rate of the material being extruded in order to compensate for the volumetric change due to compressibility of the material being processed.

28. A method for printing a component, the method comprising:
reading a first machine program defining a printing process;
estimating a melt pressure of material during the printing process;
estimating a volumetric change due to compression of the material based on the estimated melt pressure; and
determining variation in the volumetric flow rate of the material being extruded in order to compensate for the volumetric change due to compressibility of the material being processed;
producing revised machine program for a printing process; and
using the revised machine program in a printing process.

29. The method of embodiment 28 in which the segments printed by a machine program are subdivided into smaller segments, each smaller segment being provided its own compressibility compensation.

30. A method for calibrating the compressibility correction, the method comprising:
printing a component at varying flow rates of material through a flow path;
observing melt pressures of the material in the flow path as a function of flow rate;
modeling a viscosity of the material as a function of shear rate based on the melt pressures as a function of flow rate;
measuring dimensions of a printed road of the component; and
adjusting the model coefficients for the volume and bulk modulus of the material in the flow path.
